(19) United States
(12) Patent Application Publication
(10) Pub. No.: US 2026/0021634 A1
(43) Pub. Date: Jan. 22, 2026

(54) RADIATION-EMMITTING DEVICE FOR AN ADDITIVE MANUFACTURING APPARATUS

(71) Applicant: COALIA, THETFORD MINES (CA)

(72) Inventors: Andro VACHON, Thetford Mines (CA); Pascal Yves VUILLAUME, Inverness (CA); Luc DESCHAMPS, Thetford Mines (CA); Lei HU, Saint-Lambert-de-Lauzon (CA); Audrey DIOUF LEWIS, Thetford Mines (CA); Pier-Luc MARCOUX, Thetford Mines (CA)

(73) Assignee: COALIA, THETFORD MINES, QC (CA)

(21) Appl. No.: 18/871,739

(22) PCT Filed: Jun. 2, 2023
(86) PCT No.: PCT/CA2023/050758

§ 371 Date: Oct. 14, 2025

(30) Foreign Application Priority Data
Jun. 7, 2022 (CA) 3161970
Sep. 29, 2022 (CA) 3177826

(51) Int. Cl. B29C 64/295; B29C 64/118; B29C 64/209; B33Y 10/00; B33Y 30/00

(52) U.S. Cl. CPC B29C 64/295; B29C 64/118; B29C 64/209; B33Y 10/00; B33Y 30/00

(57) ABSTRACT

The disclosure concerns a 3D printhead, a radiation emission device, and processes for additive fabrication and extrusion. The printhead comprises a radiating plate configured to transmit a thermal energy to the printing material deposited on a surface. A radiation emission device may be attached to an additive fabrication or extrusion device and comprising a radiating plate and a heating element. Additive fabrication and extrusion processes using a radiation for heating a surface for deposition of the material. Characteristics of products thus produced, such as porosity rate, warping, isotropy, maximum stress, internal stress, impact resistance, bending resistance, deformation at break, rigidity modulus, crystallinity rate, and impermeability are improved.

### REFERENCES TO RELATED APPLICATIONS

This application claims priority from Canadian Patent No. 3,161,970, filed on Jun. 7, 2022, and Canadian Patent No. 3,177,826, filed on Sep. 29, 2022, with their contents being incorporated for reference.

### DOMAIN

The present disclosure generally concerns additive fabrication. More specifically, it concerns apparatuses for additive fabrication, more specifically an additive fabrication printhead, a radiation emission device, and additive fabrication processes.

### PRIOR ART

The deposition of a molten filament, or “fused deposition modeling” (FDM), which may also be called fused filament fabrication (FFF), is the most utilized printing technology for additive fabrication. Other printing processes for additive fabrication that are inspired by this technology are currently being developed, such as the deposition of droplets fused from granules, as exemplified by the APF process by the company Arburg¹, or the extrusion of a filament fused from granules, as exemplified by the Pulsar system from the company Dyze Design.

The printhead for an FDM or FFF printer should be removable. It is fed a rigid polymer filament that is mechanically advanced and comprises two sections, namely the cold area and the hot area. A thermal barrier is used between the two areas in order to minimize the transfer of unwanted heat from the hotter section to the cold section. In additive fabrication technologies that use granules, these can be advanced mechanically, such as by a feed screw, a piston or a similar mechanism.

The rigid filament is used as a pusher, in order to exert pressure on the polymer being fused, situated in the hot area. This pushing force makes it possible to generate flow through the opening of the hot nozzle. If the pushing force does not have sufficient strength, the flow will be too weak or merely stagnant.

For its part, the cold area allows for the rapid fusion of the polymer filament so that it can go from the solid state to the liquid state, and then achieve a sufficiently low viscosity to easily flow through the opening of the hot nozzle. A weak transfer of energy coming from the heating block to the polymer will not allow the polymer to reach the ideal viscosity required to extrude it.

The molten polymer is extruded through the hot nozzle and forms a layer of the object to be printed.

FIG. 1² shows a printing process for FDM or FFF additive fabrication according to the prior art. Sold in spool form (1), the thermoplastic polymer filament (2) is pushed through an extruder composed of a gear system (3), through a heating block (5), where it is melted, and a hot nozzle (6), where it is extruded in the form of a small filament. The diameter of the extruded filament at the outlet of the nozzle is significantly smaller (typically less than one millimeter) than the diameter of the filament used on the spool. The printer continuously moves a printhead, depositing the molten material at specific locations on a printing plate (8), following a path that is determined beforehand by cutting (slicer) software. When the thermoplastic polymer used cools down, it solidifies, constructing a part layer by layer.

FIG. 2 shows Volcano™ nozzles made of brass, hardened steel, and stainless steel, supplied by the company E3D. Other thermally conductive materials can be used for a printing nozzle and will be apparent to persons who put this disclosure into practice.

FIG. 3 shows an additive fabrication printhead 30, E3D model V6. The printhead 30 comprises a Bowden tube 33, required when the drive between the extruder and the printhead is not direct. This is a tube formed from a thermoplastic polymer, made of Teflon, that guides the filament between the extruder and the printhead. PTFE is used, given that it has one of the lowest coefficients of friction available on the market for solid materials (it is self-lubricating). The printhead also comprises a quick coupler 32—a standard, tight-fitting locking mechanism that allows the PTFE Bowden 33 tube to be held in place. It is important to ensure that it fully secures the tube, so that it is not possible to move it when pushed or pulled. It may also comprise a radiator 34, an area of metal fins, the purpose of which is to extract heat as quickly as possible from the thermal barrier 37 or from the filament. This cooling system may also be connected to a fan 35, which increases the speed of the forced convection heat evacuation by blowing air through the fins.

The thermal barrier 37, also called the “heat break” or “heat throat,” takes the form of a threaded metal tube that connects cold area 31 to hot area 36. Its slim geometry makes it possible to reduce the conductive transfer of heat coming from hot area 36. The thermal barrier sometimes allows the Teflon tube to pass through to the nozzle.

Hot area 36, at the other end of thermal barrier 37, comprises the heating block 38, heating cartridge (not shown), the thermistor (not shown) and the hot nozzle 39. Heating block 38 is typically made of aluminum or copper, which accumulates and transfers the heat generated by the heating element to the filament in order to initiate its fusion. The diameter of the entry opening of the heating block should correspond to the diameter of the filament used (1.75 or 2.85 mm). Hot nozzle 39 is a threaded cylindrical insert having an opening in its center allowing the flow of the molten polymer. The nozzle is screwed directly into the heating block until its upper end comes into contact with the thermal barrier. The nozzle is often made of brass, but may also be made of hardened steel or stainless steel. It has a first opening at its entrance allowing it to accommodate either filaments with a diameter of 1.77 mm or 2.85 mm. The choice of the outlet diameter is very important, because this dictates several important parameters, such as the thickness of the printed layer, the duration of the printing, the quality of the surface finish, and the dimensional precision of the printed part. Its diameter at the outlet typically varies from 0.2 mm to 1.2 mm for filament printers, and up to 10 mm for granule printers. Objects printed using a nozzle with a larger diameter tend to offer better mechanical properties (traction properties, shock resistance, etc.). According to tests performed by Prusa, objects printed with a 0.6 mm nozzle absorbed up to 25% more impact energy than those printed with a 0.4 mm nozzle.

FIG. 4 shows the components of a hot area for an additive fabrication printer as known in the prior art. Heating block 41 receives thermal barrier 42 at one end and nozzle 43 at the other end. The body of nozzle 43 generally extends over a portion of the length of heating block 41 and comes into contact with thermal barrier 42. This keeps the printing material filament from coming directly into contact with the body of heating block 41, which would necessitate increased handling and frequent cleaning of heating block 41 itself. Heating block 41 also receives a heating cartridge 44 and a thermistor 45.

Support structures are required when the printed geometry is overhanging. The support structures can be made of the same material as the printed piece and must then be detached manually when printing is finished. It is also possible to print a second, possibly soluble, material using a second printhead in order to make the support structure.

The FDM process groups a category of printers in which the printing chamber is closed and heated and the environment of which is precisely controlled in order to respond to applications for parts requiring high technical quality prototypes capable of withstanding significant mechanical forces.

Parts printed with FDM technology are capable of achieving a relatively high precision, on the order of ±0.127 mm (±0.005 in) in some specific cases.

On the other hand, the fused filament fabrication (FFF) process is generally good for prototype applications that make it possible to validate shape, ergonomics or visual aspects. An FFF type printer has an open printing chamber, where the environment is not controlled and, consequently, the filament goes from the hot extrusion heat through a cold or unevenly heated ambient environment before being deposited on the hot printing plate. However, the printed parts are generally not able to meet very high tolerances and can rarely withstand significant mechanical forces.

Adhesion between the different stacked layers during printing constitutes a major challenge for the FDM and FFF processes. Poor inter-layer adhesion increases the anisotropy of mechanical properties depending on the direction the layers or stacked in (Z axis). Unfortunately, the FDM and FFF processes present anisotropy rates that are clearly higher than other additive fabrication processes, as described in Table 1, which considerably limits their use for fabricating functional parts requiring good mechanical resistance. With the FDM process, the use of a heated chamber with a controlled environment makes it possible to reduce anisotropies in comparison to the FFF process.

TABLE 1
mechanical anisotropies according to the
additive fabrication process used.³

| 3D Printing Processes | Mechanical Anisotropy. (%) |
|---|---|
| Fused deposition modeling (FDM) | ≈50% |
| Selective laser sintering (SLS) | ≈10% |
| Material projection (Polyjet) | ≈2% |
| Tank photopolymerization (SLA) | ≈1% |

The FFF and FDM processes are low-cost, simple and quick to use. The DFM process is frequently the most economical technology, making it possible to produce parts made of thermoplastic polymers and tailor-made prototypes through additive fabrication. This process is very accessible, with several ranges of printers available on the market. The delivery times for parts printed with FFF or FDM are short (as fast as next-day delivery) due to the wide availability of this technology.

A broad range of thermoplastic materials are available, suitable for both prototyping and some functional commercial applications. In addition, the FDM and FFF processes make it possible to create parts having an internal structure with a complex geometry and that is partially hollowed out.

Despite the advantages mentioned above, the FFF and FDM processes present multiple challenges that make them less attractive for the additive fabrication of products that require precision and structural solidity.

In order to obtain a quality print, sufficient pressure needs to be applied to the molten filament from the nozzle during its deposition so that it can increase its surface contact with the previously printed surface. However, this technique causes an ovalization of the filament while it is being deposited. FIG. 5A schematically shows a deposition process of a molten filament 52 without the application of significant pressure on molten filament 52 by a nozzle 51. FIG. 5B schematically shows the same process by applying a pressure on filament 52 by a nozzle 51. Filament 52 is consequently made oval.

Despite the ovalization of the filament caused by the pressure exerted by the nozzle during its deposition, small pores will persist between the layers. These can generate concentrations of stress that partially explain the high levels of anisotropy observed in the mechanical properties of parts printed using FDM or FFF.

In conventional additive fabrication processes, the hot filament must transfer a portion of its heat to the previously printed surface in order to cause a partial and isolated remelting. This step makes it possible to obtain a molecular diffusion that consists of the creation of an entanglement of molecular chains between the filament and the already printed surface. In papers published by Sun et al.⁴ an increase in the temperature of the filament increases the contact area between the different filament layers, sometimes allowing an increased molecular diffusion. This can lead to a certain reduction of the anisotropy rate or the porosity rate. However, this requires an excessive heating of the filament, leading to a deterioration of the surface finish, an increased risk of deformation of the printed product and a potential degradation of the printing material. FIG. 6 shows an example mechanism for macromolecular diffusion of a polymer between two layers deposited during an additive fabrication process. In situations where the temperatures of the filaments are low, a very low contact area exists between the filaments, resulting in an elevated porosity rate and a very elevated anisotropy rate. An increase of the temperatures allows the material to maintain a low degree of fluidity after its deposition, with the contact area between the filaments being increased, but no molecular diffusion is produced. In this way, the porosity rate is lowered, but the anisotropy rate remains high. An optimization of the temperatures of the layers makes it possible to optimize the contact area between the layers, for example between two filaments, and allows a molecular diffusion at the interface between the two filaments. In this way, low porosity rates and anisotropy rates can be obtained.

The adhesion mechanism between the layers makes parts printed by FDM or FFF intrinsically anisotropic. The orientation of the part while it is being printed then influences its mechanical properties in each of the directions. The juxtaposition of the filaments of a circular section generates pores or “triangular gaps” that significantly affect physical and mechanical properties as well as the impermeability of the printed parts. FIG. 7 shows the mechanisms^{5,6} for formation of triangular gaps known in the art. For example, the deposition of circular of ovalized filaments 71 leaves triangular pores 72.

Warping is a major problem associated with the FDM and FFF processes. When the material extruded by the printhead cools and solidifies, its volume decreases considerably. Since the different sections of the printed part do not all cool down at the same time, the volume occupied by the plastic evolves differently from one layer to another. The differential cooling then causes the accumulation of internal stresses that pull the underlying layer upwards, deforming it. FIG. 8 shows an example process of warping of a product fabricated by additive fabrication. The new deposited layer cools, causing a volumetric shrinkage. This clings to the previous layer and pulls the printed part upwards. This leads to a risk of delamination between the printed part and the plate, or between the various layers. The greater the temperature deviation between the top layer and the deposition layer, the more the shrinkage, the internal stresses, the risks of delamination and the warping will increase.

The FDM and FFF printing processes present poor dimensional precision compared to traditional processes such as injection molding. This is explained mainly by the lower limit allowed for the diameter of the molten filament deposited and by the phenomena of warping and distortion during printing. Dimensional tolerance can reach ±0.5% of the critical dimension for the FDM process, with a lower limit of ±0.5 mm, which also turns out to be a lower dimensional precision compared to other additive fabrication processes, such as selective laser sintering, tank photopolymerization and material projection.

Parts printed using FDM are susceptible to presenting welding lines visible on the surface, and post-processing is therefore necessary in order to get a smoother surface finish, leading to additional expenses and handling.

For the FFF procedure, the dimensional precision and resolution are comparatively lower than the FDM process and other additive fabrication technologies, and is therefore not suitable for parts with fine geometries or small complex details.

Therefore, there is a need to improve the FFF and FDM additive fabrication processes in order to improve the mechanical characteristics and the quality of products printed using these processes.

### SUMMARY OF THE DISCLOSURE

We have found that the devices and processes from this disclosure will improve the characteristics of products made by additive fabrication or by extrusion. More specifically, one or more characteristics of a product made by additive fabrication can be modulated, including the porosity rate, warping, isotropy, maximum stress, internal stress, impact resistance, bending resistance, deformation at break, and the rigidity modulus.

This disclosure describes devices for additive fabrication comprising a means for emission of a thermal radiation, in particular a radiating plate. Processes for additive fabrication and extrusion of materials using a radiation are also described.

This disclosure concerns an additive fabrication printhead, comprising a radiation emission device and a printing nozzle configured to deliver a printing material. The radiation emission device includes a radiating plate, comprising a proximal surface and a distal surface, and at least one heating element. The radiation emission device is configured to receive the printing nozzle so that the nozzle is close to the radiating plate.

This disclosure further concerns an additive fabrication process using a print head comprising a nozzle configured to deliver a printing material, and a radiation emission device comprising a radiating plate and at least one first heating element. The process comprises the following steps: heating the printing material circulating in the nozzle, extruding a first quantity of the heated printing material towards a deposition surface through the nozzle, forming a deposition layer, heating at least one part of the deposition layer by a radiation emanating from the radiating plate, extruding at least one second quantity of the heated printing material through the nozzle onto the part of the deposition layer heated in this way.

This disclosure further concerns a radiation emission device for an additive fabrication apparatus, comprising a radiating plate, configured to be installed close to the apparatus, comprising a proximal surface and a distal surface, and at least one heating element configured to heat the radiating plate.

The disclosure further concerns a process for extrusion of a material, comprising the following steps: heating the material, heating by radiation at least one part of a deposition surface, extruding the heated material towards the deposition surface.

This disclosure further concerns an additive fabrication process comprising the following steps: heating a material, extruding a first quantity of the heated material towards a deposition surface, forming a deposition layer, heating at least one part of the deposition layer by a radiation, extruding at least one second quantity of the heated material onto the part of the deposition layer heated in this way.

This disclosure also concerns the use of a radiating plate disposed near a printing nozzle in an additive fabrication process. This use makes it possible to modulate one or more characteristics of a product made by additive fabrication. These characteristics include the porosity rate, warping, isotropy, maximum stress, internal stress, impact resistance, bending resistance, deformation at break, rigidity modulus and impermeability.

This disclosure also concerns the use of a radiating plate integrated into a printhead in an additive fabrication process. This use makes it possible to modulate one or more characteristics of a product made by additive fabrication. These characteristics include the porosity rate, warping, isotropy, maximum stress, internal stress, impact resistance, bending resistance, deformation at break, rigidity modulus and impermeability.

According to certain embodiments, the nozzle comprises an extrusion tip and is received by the radiation emission device so that the extrusion tip extends beyond the distal surface of the radiating plate.

According to certain embodiments, the extrusion tip extends from about 0.1 to around 500 millimeters beyond the distal surface of the radiating plate. According to other embodiments, the extrusion tip extends from about 0.1 to about 200 millimeters beyond the distal surface of the radiating plate. According to other embodiments, the extrusion tip extends from about 0.5 to about 50 millimeters beyond the distal surface of the radiating plate. According to other embodiments, the extrusion tip extends from about 1 to about 5 millimeters beyond the distal surface of the radiating plate.

According to certain embodiments, said at least one first heating element is configured to transmit a thermal energy by conduction to the proximal surface of the radiating plate.

According to certain embodiments, the radiating plate is configured to transmit the thermal energy from at least one first heating element by radiation via the distal surface to the printing material delivered onto a deposition surface situated close under the distal surface.

According to certain embodiments, the printhead is configured to be mobile in relation to a deposition surface.

according to certain embodiments, the printhead further comprises a heating block, comprising at least one second heating element and configured to receive an upper end of the nozzle. The heating block is configured to heat the printing material circulating in the printing nozzle.

According to certain embodiments, the printhead further comprises a mounting case configured to connect the proximal surface of the heating plate and the heating block.

According to certain embodiments, the radiation emission device further comprises at least one first thermocouple in direct contact with said at least one first heating element. According to other embodiments, said at least one first thermocouple is in direct contact with the radiating plate.

According to certain embodiments, the printhead further comprises a first temperature controller, said at least one first heating element being functionally connected to the first temperature controller. According to certain embodiments, the printhead further comprises a second temperature controller functionally connected to at least one second heating element. According to certain embodiments, the printhead comprises a temperature controller functionally connected to at least one first heating element and at least one second heating element.

According to certain embodiments, the heating block comprises at least one first heating element and said at least one second heating element. According to certain embodiments, said at least one first heating element and said at least one second heating element form a single heating element and the radiating plate is configured to transmit the thermal energy from the sole heating element by radiation via the distal surface to the printing material delivered onto the deposition surface situated close under the distal surface.

According to certain embodiments, the mounting case defines the insulation area between the case and said at least one first heating element. According to certain embodiments, the mounting case defines the insulation area between the case and the heating block. According to certain embodiments, the insulation area comprises a space of about 0 to about 100 millimeters According to certain embodiments, the isolation area comprises a space of about 0.1 to about 50 millimeters. According to certain embodiments, the insulation area comprises a space from about 1 to about 10 millimeters. According to certain embodiments, the insulation area comprises at least any one of: a reflective surface, an insulating material or an air space.

According to certain embodiments, the radiating plate has an annular shape. According to certain embodiments, said at least one first heating element has an annular shape.

According to certain embodiments, the printhead is configured is configured to receive the printing material in the form of a filament. According to certain embodiments, the printhead is configured is configured to receive the printing material in the form of granules.

According to certain embodiments, the material is a filament before heating. According to certain embodiments, the material is in the form of granules before heating.

According to certain embodiments, the material is heated by at least one of the methods chosen from a group consisting of: conduction, convection.

According to certain embodiments, the material is heated to a temperature above its glass transition temperature. According to certain embodiments, the material is heated to a temperature above its melting temperature.

According to certain embodiments, the material comprises an amorphous polymer, the amorphous polymer having a glass transition temperature (T_{g}), and at least one part of the deposition later is heated by radiation to a temperature of about 20° C. below to about 200° C. above the T_{g}, or of about 10° C. below to about 100° C. above the T_{g}, or of about 5° C. below to about 50° C. above the T_{g}.

According to certain embodiments, the material comprises a block copolymer, each block having at least one glass transition temperature (T_{g}) and optionally at least one melting temperature (Tₘ), and at least one part of the deposition layer being heated by radiation to a temperature of about 20° C. below to the lowest T_{g} among the T_{g}s of the blocks to about 200° C. above the highest T_{g}, optionally to about 100° C. above the highest Tₘ, out of the T_{g}s, and optionally the Tₘs of the blocks. According to certain embodiments, said at least one part of the deposition layer being heated by radiation to a temperature of about 10° C. below to the lowest T_{g} among the T_{g}s of the blocks to about 100° C. above the highest T_{g}, optionally to about 100° C. above the highest Tₘ, out of the T_{g}s, and optionally the Tₘs of the blocks. According to certain embodiments, said at least one part of the deposition layer being heated by radiation to a temperature of about 5° C. below to the lowest T_{g} among the T_{g}s of the blocks to about 50° C. above the highest T_{g}, optionally to about 50° C. above the highest Tₘ, out of the T_{g}s, and optionally the Tₘs of the blocks.

According to certain embodiments, the material comprises semi-crystalline polymer, the semi-crystalline polymer having a glass transition temperature (T_{g}) and a melting temperature (Tₘ), and at least one part of the deposition later is heated by radiation to a temperature of about 20° C. below the T_{g} to about 100° C. above the Tₘ, or of about 10° C. below the T_{g} to about 100° C. above the Tₘ, or of about 5° C. below the T_{g} to about 50° C. above the Tₘ.

According to certain embodiments, the material comprises a mixture comprising at least two components chosen from among the group consisting of: an amorphous polymer, a semi-crystalline polymer and a block copolymer, each component having at least one glass transition temperature (T_{g}) optionally at least one melting temperature (Tₘ), and at least one part of the deposition layer being heated by radiation to a temperature of about 20° C. below to the lowest T_{g} among the T_{g}s of the mixture components to about 200° C. above the highest T_{g}, optionally to about 100° C. of the highest Tₘ, out of the T_{g}s, and optionally the Tₘs of the mixture components. According to certain embodiments, said at least one part of the deposition layer being heated by radiation to a temperature of about 10° C. below to the lowest T_{g} among the T_{g}s of the mixture components to about 100° C. above the highest T_{g}, optionally to about 100° C. of the highest Tₘ, out of the T_{g}s, and optionally the Tₘs of the mixture components. According to certain embodiments, said at least one part of the deposition layer being heated by radiation to a temperature of about 5° C. below to the lowest T_{g} among the T_{g}s of the mixture components to about 50° C. above the highest T_{g}, optionally to about 50° C. of the highest Tₘ, out of the T_{g}s, and optionally the Tₘs of the mixture components.

According to certain embodiments, the printhead is mobile in relation to the deposition layer, and a temperature of at least one first heating element is adjusted as a function of a movement speed of the printhead in relation to the deposition layer.

According to certain embodiments, a temperature of at least one first heating element is adjusted as a function of an optimal absorption wavelength of the material.

According to certain embodiments, the radiation emission device is configured to be attached to an extrusion device. According to certain embodiments, the radiation emission device is configured to be attached to a printhead.

According to certain embodiments, the radiation allows heating of the extruded material in order to slow down its cooling.

According to certain embodiments, the radiation is a thermal radiation and a temperature from a radiation source is adjusted as a function of a movement speed of the source in relation to the deposition surface.

According to certain embodiments, a radiation is a thermal radiation and a temperature from a radiation source is adjusted as a function of an optimal absorption wavelength of the material.

According to certain embodiments, the deposition surface is a printing plate. According to certain embodiments, the deposition surface is a layer of the material.

Other elements and advantages of this disclosure will be apparent upon reading the detailed description that follows. The detailed description and the specific examples indicate embodiments and are given for illustrative purposes. The scope of the claims should not be limited by these embodiments, but should be given the broadest interpretation that the description permits.

### BRIEF DESCRIPTION OF THE DRAWINGS

FIG. 1 is a representation of a printing process by additive fabrication according to the prior art.

FIG. 2 shows Volcano nozzles made of brass, hardened steel, and stainless steel, supplied by the company E3D, according to the prior art.

FIG. 3 is a diagram of an additive fabrication printhead, model E3D V6, according to the prior art.

FIG. 4 shows the components of a heating block according to the prior art.

FIGS. 5A and 5B are representations of an additive fabrication process for deposition of a filament without pressure applied (FIG. 5A) and with a pressure applied (FIG. 5B) by a nozzle during its deposition according to the prior art.

FIG. 6 is a representation of the effects of temperature on the macromolecular diffusion between the filaments.

FIG. 7 is a representation of the triangular gap formation mechanisms according to the prior art.

FIG. 8 is a representation of the phenomenon of volumetric shrinkage between the deposition layer and the top layer during cooling, which can result in a warping process or in the delamination of the printed part.

FIG. 9 is a representation of the process of energy transfer by radiation towards the deposited material.

FIG. 10 is a representation of a printhead according to an example embodiment of this disclosure.

FIG. 11 is a perspective view of a radiation emission device according to an example embodiment of this disclosure.

FIG. 12 is a cross section of a radiation emission device according to an example embodiment of this disclosure.

FIG. 13 is a view from underneath of a radiation emission device according to an example embodiment of this disclosure.

FIG. 14 represents the thermal profiles of two layers formed according to an additive fabrication process according to an example embodiment of this disclosure.

FIG. 15 shows a sample specimens printed with indication of the print axes according to an example embodiment of this disclosure.

FIG. 16 shows the dimensions, in millimeters, of an ASTM D638 type IV sample according to an example embodiment of this disclosure⁷.

FIG. 17 is a graph illustrating the evolution of the Young's Modulus of a sample printed by additive fabrication as a function of the print speed and the configuration of a radiating plate heating system, according to an example embodiment of this disclosure.

FIG. 18 is a graph illustrating the evolution of the maximum stress of a sample printed by additive fabrication as a function of the print speed and the configuration of a radiating plate heating system, according to an example embodiment of this disclosure.

FIG. 19 is a graph illustrating the evolution of the elongation at break of a sample printed by additive fabrication as a function of the print speed and the configuration of a radiating plate heating system, according to an example embodiment of this disclosure.

FIGS. 20A and 20B are x-ray tomography images of the cross section of a sample printed by additive fabrication without (FIG. 20A) and with (FIG. 20B) a radiant heating element according to an example embodiment of this disclosure.

FIG. 21 is a schematic representation of a potential mechanism for reduction of the porosity rate according to an example embodiment of this disclosure.

FIG. 22 is a graph illustrating the evolution of the Young's Modulus of a sample printed by additive fabrication as a function temperature, and as a function of the apparatus used, according to an example embodiment of this disclosure.

FIG. 23 is a graph illustrating the evolution of the maximum stress of a sample printed by additive fabrication as a function of temperature, and as a function of the apparatus used, according to an example embodiment of this disclosure.

FIG. 24 is a graph illustrating the evolution of the elongation at break of a sample printed by additive fabrication as a function of temperature, and as a function of the apparatus used, according to an example embodiment of this disclosure.

FIGS. 25A, 25B, 25C and 25D are x-ray tomography images of a sample printed by additive fabrication according to an example embodiment of this disclosure-FIG. 25A: cross section, printed without a radiant heating element; FIG. 25B: cross section, printed with a radiant heating element; FIG. 25C: elevation section, printed without a radiant heating element; and FIG. 25D: elevation section, printed without a radiant heating element.

FIG. 26 is a schematic representation of the localized heating of the radiant heating system according to an example embodiment of this disclosure.

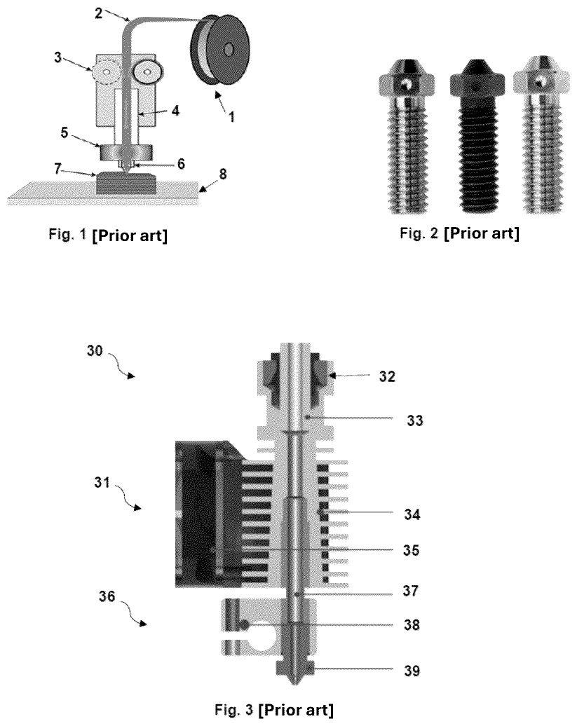

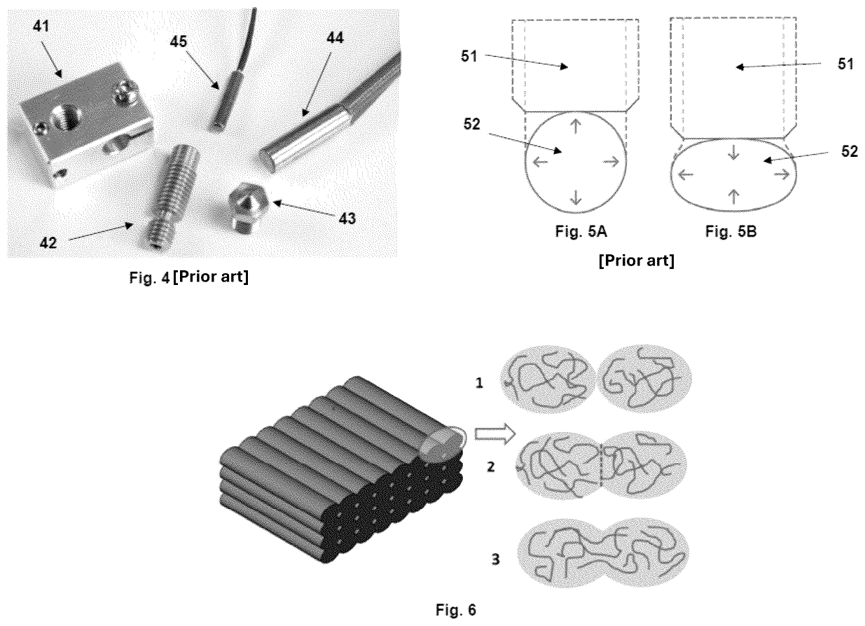

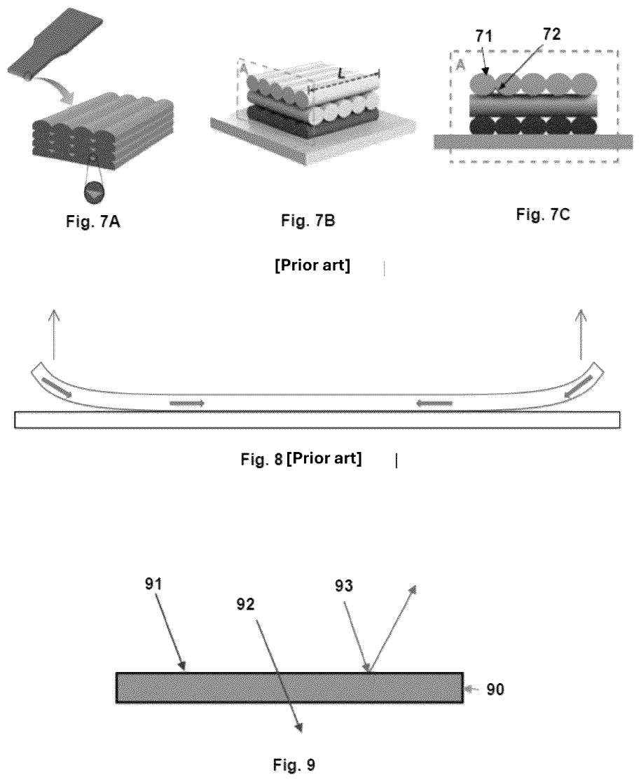

### DETAILED DESCRIPTION

In this disclosure, the term “additive fabrication” comprises, but is not limited to, the processes for formation of an object by deposition or by another means of addition by layers, including printing in three dimensions. More specifically, the term “additive fabrication” comprises the techniques for forming an object by filaments and by feeding granules, as well as the formation of an object by extrusion of granules.

In this disclosure, the term “deposition surface” comprises any surface that receives the material according to this disclosure. More specifically, the term “deposition surface” comprises, but is not limited to, a printing plate and the surface of a layer of material previously deposited. A person versed in the art would note that during an additive fabrication process, the first layer of material is deposited on the printing plate, and that a subsequent layer is deposited on the previously deposited layer.

In this disclosure, the term “deposition layer” comprises, but is not limited to, a layer of material previously deposited or supplied independently.

In this disclosure, the term “top layer” comprises, but is not limited to, a layer of material in the process of fabrication. More specifically, the term “top layer” comprises a layer of material deposited according to this disclosure onto a deposition surface.

Unless indicated otherwise, the definitions and embodiments described herein are applicable to all embodiments and aspects of this disclosure for which they are suitable, as would be understood by a person skilled in the art.

As used in this application and in the claims, the words comprising (and any form of comprising, such as “comprises” and “comprise”), “having” (and any form of “to have”, such as “have” and “has”), “including” (and any form of inclusion, such as “includes” and “included”) or “containing” (and any form of containing, such as “contains” and “contained”) are inclusive or open and do not exclude elements or steps of supplementary processes not cited.

The term “constituted” and its derivatives, as used herein, are meant to be closed terms that specify the presence of declared characteristics, elements, components, groups, whole numbers and/or steps, and also exclude the presence of other undeclared characteristics, elements, components, groups, whole numbers and/or steps.

The term “essentially consisting of”, as used herein, is meant to specify the presence of stated characteristics, elements, components, groups, whole numbers and/or steps, as well as those that do not materially affect the base elements and new characteristic(s) of these characteristics, elements, components, groups, whole numbers and/or steps.

The terms “about,” “appreciably,” and “approximately” as used herein mean a reasonable amount of deviation from the modified term, so that the final result is not significantly changed. These terms of degree should be interpreted as including a deviation of at least ±5% of the modified term if this deviation does not negate the meaning of the word that it modifies or unless the context suggests otherwise to a skilled person.

As used in this application, the singular forms of “a,” “an,” and “the” include plural references unless the context clearly states otherwise.

The term “and/or” as used herein means that the stated elements are present or used, individually or in combination. In effect, the term means that “at least one of” or “one or more” of the stated elements are used or present.

The term “appropriate” as it is used here means that the selection of particular conditions will depend on the specific steps to be carried out, the identity of the components and/or the specific use of the components, but the selection would be quite within the scope of a person skilled in the art.

This disclosure concerns an additive fabrication printhead. The head comprises a radiation emission device and a nozzle configured for delivering a material. The radiation emission device comprises a radiating plate and at least one first heating element. The radiation emission device is configured to receive the nozzle so that the nozzle is close to the radiating plate. The radiating plate comprises a proximal surface and a distal surface.

The nozzle can be at a distance from the radiating plate so that the body of the nozzle does not come into contact with the radiating plate. The distance between the nozzle and the radiating plate makes it possible to reduce thermal contamination between the nozzle and the radiating plate. In effect, the temperatures of the nozzle and the radiating plate can be different and a direct contact between these two components can lead to an unexpected transfer of heat. The distance between the nozzle and the radiating plate can be from about 0.1 to about 500 millimeters.

The nozzle comprises an extrusion tip. The radiation emission device receives the nozzle so that the extrusion tip extends beyond the distal surface of the radiating plate. The nozzle can be a commercial disposable nozzle, such as a SuperVolcano nozzle by the company E3D. A person skilled in the art will understand that adequate modifications to nozzles currently available for sale can be carried out in order to put this disclosure into practice.

The extrusion tip can extend from about 0.1 to about 500 millimeters, from about 0.1 to about 200 millimeters, from about 0.5 to about 50 millimeters, or from about 1 to about 5 millimeters beyond the distal surface of the radiating plate, depending on the characteristics of the material used and depending on the characteristics of the object to be fabricated. For example, the extrusion tip can go past the distal surface by a very small distance when a high power must be transmitted quickly to the deposition surface.

The at least one first heating element can be configured to transmit a thermal energy by conduction to the proximal surface of the radiating plate. In this case, the at least one first heating element is in direct contact with the proximal surface of the radiating plate. One or more conductive materials can also be interposed between the proximal surface and the first heating element, covering all or part of the proximal surface. The heat from the first heating element will then be transmitted more diffusely to the proximal surface. The radiating plate can also be heated by other means, such as by induction or electrically.

The radiating plate may be a high emissivity radiating plate. The radiating plate is configured to transmit the thermal energy from at least one first heating element by radiation via the distal surface to the material delivered onto a deposition surface situated close under the distal surface. The distal surface of the radiating plate can have a high emissivity constant. Different techniques can be used to improve the emissivity of the distal surface. For example, the distal surface can include anodized aluminum or abraded or oxidized materials. The distal surface can include other materials, alone or in combination, having a high emissivity coefficient.

According to certain embodiments, the radiating plate is configured to protect the heating element from any direct contact with the polymer coming from the nozzle, from the deposition surface or from the top surface. This protection element makes it possible to reduce the distance separating the distal surface from the deposition surface and the top surface and because of this to increase the amount of energy transferred to the polymer and to minimize the length of the nozzle.

The additive fabrication printhead can be configured to be mobile in relation to a deposition surface. The mobility is not limited to a number of axes. For example, an additive fabrication printhead can be installed on a robotic arm in order to be moved through 3 axes in relation to the deposition surface.

The additive fabrication printhead can further comprise a heating block, comprising at least one second heating element and configured to receive an upper end of the nozzle. For example, the nozzle can comprise a screwable part that can be screwed into the body of the heating block. A printing material circulates in the nozzle, and the heating block is configured to heat the material circulating in the nozzle. The heating block can include the material that accumulates and transmit the heat produced through the at least one second heating element towards the nozzle and towards the printing material. For example, the heating block can include aluminum or copper.

The additive fabrication printhead can further comprise a mounting case configured to connect the proximal surface of the heating plate and the heating block. The mounting case can define the insulation area between the case and said at least one first heating element. The mounting case can define the insulation area between the case and the heating block. The insulation area can comprise a space of about 0 to about 100 millimeters, or a space of about 0.1 to about 50 millimeters, or a space of about 1 to about 10 millimeters. The insulation area can also comprise at least one reflecting surface, an insulation material, an air space, or a combination of these. The reflecting surface can be obtained in various ways, such as polishing. The mounting case can have standardized dimensions, facilitating the installation of a radiation emission device out of multiple types of additive fabrication devices available on the market, for example, FDM or FFF printers, granule-fed additive fabrication devices, or droplet deposition additive fabrication devices. The radiating plate can be connected to the mounting case using screws. The screws can be assembled below the mounting case in order to avoid any discontinuity on the distal surface that could be caused by the presence of the screw heads. A hole can be provided on the mounting case to allow the passage of the wires for the heating element power supply and thermocouple.

The mounting case can be configured to be attached to the heating block, for example by means of mounting screws, such as by using hex socket screws. Other means of attachment include hooks, clips, or other suitable means. The mounting case may optionally be configured to be attached to other elements of the additive fabrication apparatus.

The radiation emission device can further comprise at least one first thermocouple in direct contact with said at least one first heating element. The at least one first thermocouple can also be in direct contact with the radiating plate. The temperature of the at least one first heating element or the radiating plate can also be measured by other means, such as by means of a thermal camera.

The additive fabrication printhead can further comprise a first temperature controller functionally connected to the first heating element. It can further comprise a second temperature controller functionally connected to the second heating element. The first temperature controller can modify the temperature of the first heating element as a function of the temperature of the radiating plate or of the first heating element. Optionally, the at least one first heating element, the at least one second heating element, the at least one first thermocouple and the at least one second thermocouple, or a combination of these, can be functionally connected to the same temperature controller.

The first thermocouple and the first temperature controller can operate in a closed loop. In such an embodiment, the first thermocouple continually measures the temperature of the radiating plate and the temperature controller adjusts the temperature of the first heating element as a function of the temperature measured by the first thermocouple.

In certain embodiments, the radiating plate can also be an extension of the heating block. The heating block can comprise the at least one first heating element and the at least second heating element. In other embodiments, the first heating element and the second heating element form a single heating element. The radiating plate is configured to transmit the thermal energy from the single heating element, from the fires and from the second heating element, by radiation via said distal surface to the material delivered onto a deposition surface situated close under the distal surface. In these embodiments, the temperature of the heating block and the temperature of the radiating plate are similar.

The radiating plate can have several shapes, for example, it can be circular, annular, triangular, square, rectangular, or another suitable shape. A circular or annular geometry makes it possible to ensure the consistency of the exposure duration and the power transferred, no matter which direction the printhead moves.

The dimensions of the radiating plate can be adapted depending on the dimensions of the object to be fabricated. For example, an annular shaped radiating plate with a large exterior diameter can be used when a part with large dimensions is being fabricated. The use of a larger distal surface makes it possible to increase the energy transferred to the material. On the other hand, an annular shaped radiating plate with a smaller exterior diameter can be used when a part with small dimensions is fabricated.

In certain embodiments, the printing nozzle has a diameter of about 0.1 mm to about 10 mm. In certain embodiments, the printing nozzle has a diameter of about 0.2 mm to about 5 mm. In certain embodiments, the printing nozzle has a diameter of about 0.2 mm to about 2.0 mm. In certain embodiments, the printing nozzle has a diameter of about 0.2 mm to about 0.8 mm.

In certain embodiments, the distal surface has an area of about 200 to about 200,000 mm². In certain embodiments, the distal surface has an area of about 500 to about 10,000 mm². In certain embodiments, the distal surface has an area of about 1000 to about 2000 mm².

The at least one first heating element can have an annular shape. The at least one first heating element can be in the same shape as the radiating plate and along its perimeter. The radiating plate can also be heated by multiple heating elements disposed in a suitable arrangement. For example, multiple heating elements can be disposed in a star formation.

The additive fabrication printhead can be designed to be adapted to an FDM or FFF type fused filament deposition printer. The FDM or FFF printer can have a printing chamber, that can be heated or not. The additive fabrication printhead can be used with a broad range of thermoplastic polymer materials that can be formulated with or without fillers. The additive fabrication printhead can also be designed to be adapted to a printer using a granule feed technology. The additive fabrication printhead can also be adapted for a droplet deposition additive fabrication process.

This disclosure also concerns an additive fabrication process using the additive fabrication printhead described above. The process comprises the following steps: heating the material circulating in the nozzle, extruding a first quantity of the material towards a deposition surface through the nozzle, forming a deposition layer, heating at least one part of the deposition layer by a radiation emanating from the radiating plate, extruding at least one second quantity of the material through the nozzle onto the part of the deposition layer heated in this way.

The material can be an amorphous polymer, such as a polyetherimide (PEI), a polycarbonate (PC), an acrylonitrile butadiene styrene (ABS), an acrylonitrile styrene acrylate (ASA), a poly(methyl methacrylate) (PMMA), a polysulfone (PSU), a polyphenylsulfone (PPSU), etc.

The material can be a semi-crystalline polymer, such as a polylactic acid (PLA), a polyamide (PA), a polyethylene (PE), a polypropylene (PP), a polyphenylene sulfide (PPS), a polyether ether ketone (PEEK), etc.

The material can be a thermoplastic elastomer (TPE) of the block copolymer type (rigid/soft), such as block copolymer consisting of polyurethane and polyether or polyester (TPU), consisting of polyester and polyether (TPC), consisting of copolyamide and polyether (TPA), consisting of polystyrene and polybutadiene (TPS). The material can be a mixture of polymers, such as a mixture of polycarbonate (PC) and acrylonitrile butadiene styrene (ABS), also known by the acronym PC/ABS.

The examples of materials given above are not limiting. Other suitable materials and mixtures will be obvious to persons skilled in the art who put this disclosure into practice, without deviating from the principles stated here.

The material circulating in the nozzle can be heated by conduction, by convection, or by a combination of these. The material can be heated to a temperature higher than its glass transition temperature or its melting temperature. For example, an amorphous polymer can be extruded at a temperature above its glass transition temperature. However, the determination of the melting temperature is not possible for an amorphous polymer since its internal structure does not have crystalline structures. In the case of semi-crystalline polymers, these are heated to a temperature above their melting temperature before being extruded.

As mentioned above, the radiating plate is configured to protect the heating element from any direct contact with the polymer coming from the nozzle, from the deposition surface or from the top surface. This protection element makes it possible to reduce the distance separating the distal surface from the deposition surface and the top surface and because of this to increase the amount of energy transferred to the polymer and to minimize the length of the nozzle. Thus, the distance between the radiating plate and the deposition layer or the deposition surface can be minimized in order to optimize the transfer of heat by radiation. This distance can be on the order of only a few millimeters. For example, the distance can be from about 0.15 to about 500 millimeters, from about 0.15 to about 200 millimeters, from about 0.5 to about 50 millimeters, or from about 1 to about 10 millimeters.

In an non-limiting example, a portion of the deposition layer can be heated by radiation to a temperature close to or above the glass transition or melting temperature of the material. The portion can be a very fine thickness layer. A portion of the top layer deposited on the deposition layer can also be heated by radiation to a temperature close to or above the glass transition or melting temperature of the material. A person skilled in the art will note that the radiation can also heat a deeper thickness of the layer. In other examples, the radiation can heat the entire thickness of the layer, or a thickness including more than one layer.

The material can comprise an amorphous polymer having a glass transition temperature. In this embodiment, the portion of the deposition layer can be heated by the radiation to a temperature of about 20° C. below to about 200° C. above, of about 10° C. below to about 100° C. above, of about 5° C. below to about 50° C. above the glass transition temperature of the material.

The material can comprise a semi-crystalline polymer, having a glass transition temperature and a melting temperature. In this embodiment, the portion of the deposition layer can be heated by the radiation to a temperature of about 20° C. below to about 100° C. above, of about 10° C. below to about 100° C. above, or of about 5° C. below to about 50° C. above, respectively, the glass transition temperature and the melting temperature of the material.

The material can comprise one or multiple block copolymers. Each block in each block copolymer has a glass transition temperature. Each block can also optionally have a melting temperature, for example if it is a semi-crystalline block. The glass transition temperatures and, optionally, the melting temperatures of the blocks can be different. In these embodiments, the portion of the deposition layer can be heated to a temperature of about 20° C. below to about 200° C. above, or of about 10° C. below to about 100° C. above, or of about 5° C. below to about 50° C. above, respectively, the lowest glass transition temperature of the glass transition temperatures of the blocks, and the highest glass transition temperature among the glass transition temperatures of the material. When one or more melting temperatures are present, the portion of the deposition layer can optionally be heated to a temperature of about 20° C. below to about 100° C. above, of about 10° C. below to about 100° C. above, or of about 5° C. below to about 50° C. above, respectively, the lowest glass transition temperature among the glass transition temperatures of the blocks, and the highest melting temperature among the melting temperatures of the blocks.

The operational parameters described for the embodiments comprising one or more block copolymers are also applicable to the embodiments comprising mixtures of polymers, including mixtures comprising amorphous polymers, mixtures comprising semi-crystalline polymers, mixtures comprising block copolymers, or combinations of these. Thus, the polymers and copolymers composing the mixture can have one or more glass transition temperatures and, optionally, one or more melting temperatures. The parameters described regarding the glass transition and melting temperatures of blocks from a block copolymer are applicable with regard to the glass transition and melting temperatures of the polymers and copolymers composing the mixtures.

The additive fabrication printhead can be mobile in relation to a deposition layer. The movement of the additive fabrication printhead can be guided according to a path determined by cutting software. The temperature of the at least one first heating element can be adjusted as a function of the movement speed of the head in relation to the deposition layer.

The at least one first heating element can be deactivated temporarily, or generate a reduction of its heating power, when the surface area of the layer to be fabricated is less than the surface area of the radiating plate, in order to avoid an overheating or a degradation of the polymer. In certain examples, the surface area of the deposition surface of the layer to be fabricated can be determined by cutting software and compared to the surface area of the radiating plate.

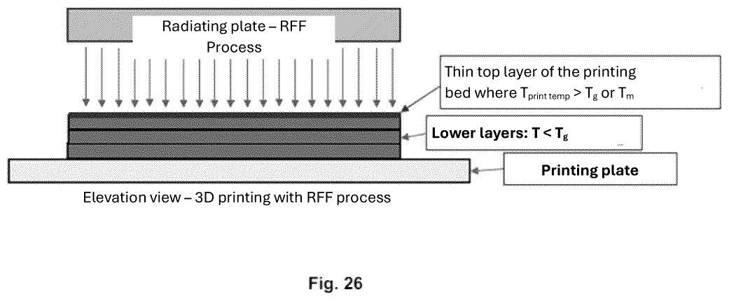

Without being bound by theory, the radiant heating system of this application allows for isolated heating, heating the polymer for a short period of time, which makes it possible to avoid an overexposure to heating and possible the degradation of the polymer. The radiant system also makes localized heating possible, directing the flow of heating only to the required location: on a thin layer at the surface of the top layer, close to the deposition area of the molten filament. This strategy makes it possible to locally increase T_{polymer surface}>T_{g} (glass transition temperature) or even Tₘ (melting temperature-semi-crystalline), while ensuring that the lower layers remain at a T_{polymer}<T_{g}. In this way, the polymer remains hot only over a thin surface layer because the heating is isolated and the thermal conductivity constant of the thermoplastic polymers is low (e.g.: K(PEI)=0.24 W/m*K) (see FIG. 26).

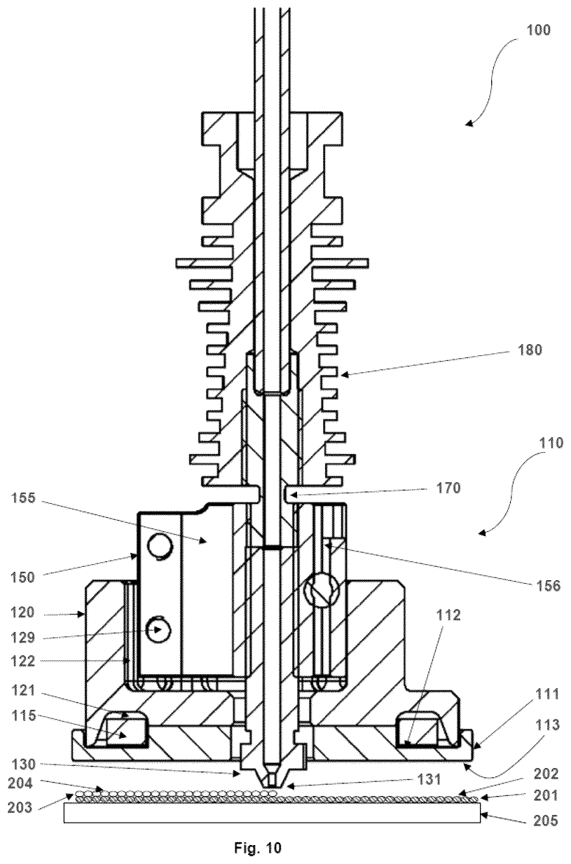

FIG. 9 shows certain interactions between an energy and an object 90, which can be deposition surface, a deposition layer, a top surface, a printing plate, or another object. The energy emitted by the radiating plate is not absorbed fully by the object, for example by a layer of a previously deposited material. A portion 91 of this energy can be absorbed. A portion 92 of this energy can be transmitted through the object, for example through the polymer forming a layer of the material. A portion 93 can simply be reflected at its surface. Only the energy absorbed contributes to the argumentation [sic] of the temperature of the surface material. In order to further optimize the power absorbed, the temperature of the radiating plate can be determined so that the wavelength corresponding to the energy emission peak of the radiating plate corresponds to the wavelength of one of the high energy absorption peaks of the material previously deposited.

These absorption peaks vary from one material to another, as a function of their chemical compositions. Each printing material can comprise multiple absorption peaks, including at least one maximum absorption peak. The temperature corresponding the wavelength Amax associated with the energy emission peak is estimated by the Wien displacement law:

$${λ}_{max} = \frac{hc}{4.96511423174 kT} = \frac{2.89777291 \times {10}^{- 3} m \cdot K}{T}$$

Where h is the Planck constant, k is the Boltzmann constant and c, the speed of light in a vacuum, and T is the temperature of the radiating plate in degrees Kelvin.

Specific fillers allowing for increasing the absorption of the energy emitted by the radiating plate can be integrated with the material. These fillers can include, for example, carbonaceous fillers, such as carbon black, graphite, carbon fibers, porous carbon fibers, carbon nanoparticles, graphenes. The can also include nickel nanoparticles, optionally coated with silica and carbon, gold nanoparticles coated with graphene, or nickel oxide nanoparticles coated with multi-wall carbon nanotubes (also known as “MWCNT”).

The temperature of the at least one first heating element can be adjusted as a function of an optimal wavelength of the material. The optimal wavelength of the material can be an optimal absorption wavelength. The optimal wavelength can correspond to the maximum absorption peak or to another known absorption peak. In certain examples, the maximum absorption peak of the material can correspond to temperature at which the radiating plate and the at least one first heating element can operate. In other examples, the maximum absorption peak of the material can correspond to a temperature exceeding the maximum operating temperature of the radiating plate or the at least one first heating element. In these examples, the wavelength of another absorption peak of the material can be selected from among known absorption peaks. In a predictive example, this selection can be operated by cutting software. In another predictive example, this selection can be operated by the temperature controller.

The use of a high-power radiation can cause a degradation of the printing material also irradiated, for example by oxidation. When the radiant system is used at high power, the process can be executed in a closed chamber, and an inert gas such as nitrogen or argon can be used in the chamber in order to avoid the degradation of the material at the deposition surface that is exposed to the radiation.

This disclosure also concerns a radiation emission device for an additive fabrication apparatus, comprising a radiating plate, and at least one heating element configured to heat the radiating plate. The radiating plate is configured to be installed close to the apparatus. The radiating plate comprises a proximal surface and a distal surface. The heating element can be configured to transmit a thermal energy by conduction to the proximal surface.

The radiating plate can be configured to transmit the thermal energy from at least one heating element by radiation via the distal surface to the material delivered to a deposition surface.

The radiation emission device can further comprise a thermocouple in direct contact with the at least one heating element or in direct contact with the radiating plate. A temperature controller can be functionally connected to the at least one heating element.

The radiation emission device can be provided independently of an additive fabrication apparatus. It can then be configured to be attached to such an apparatus, or to an extrusion apparatus. To this end, the radiation emission device can comprise a means for attachment to such apparatuses, such as screw-on brackets, hooks, clamps.

The radiating plate can have an annular shape. The heating element can have an annular shape. The radiating plate and the heating element can have other shapes, for example, the can be square, triangular, oval or of another suitable shape.

This disclosure also concerns a process for extrusion of a material in which a deposition surface is heated in isolation to a temperature close to or above the glass transition temperature or the melting temperature of the material. The extruded materials that come into contact with a cold deposition surface are subjected to a sudden cooling at the surface area in contact with the deposition surface, while the body of the extruded material remains at a higher temperature. This difference in the rate of cooling within the material can cause deformations of the extruded product, as well as internal tensions and distortions that can make the product more fragile. However, the heating of the entire deposition surface, or the entire fabrication environment, such as a fabrication chamber, can lead to a softening of the deposited material, a reduction in the adhesion of the material to the fabrication plate and a thermal degradation of the material. For example, in an FFF or FDF additive fabrication process, a deposited polymer may, when overheated, lose the ability to support the top layers, or soften at its surface in contact with the printing plate. This would result in a failure of the fabrication, for example caused by a collapse of the structure being fabricated, or by a movement of the object being fabricated on the plate in relation to the fabrication device.

The process for extrusion of a material, comprises the following steps: heating the material, heating by radiation at least one part of a deposition surface, extruding the material towards the deposition surface. The material can be heated by conduction, by convection, or by a combination of the two. The material can be heated to a temperature close to or above its glass transition temperature or its melting temperature.

The radiation also makes it possible to heat said extruded material in order to slow down its cooling, thereby reducing deformations and stresses caused by rapid cooling, such as in an unheated printing chamber.

The material used in the extrusion process can be the same material used in the embodiments of the additive fabrication process, using a printhead according to this disclosure as described above. The operational parameters for the additive fabrication process using a printhead according to this disclosure are also applicable to the extrusion process.

The radiation can be a thermal radiation. The temperature of a radiation source can be adjusted as a function of the movement speed of the source in relation to the deposition surface. The temperature of a radiation source can also be adjusted as a function of an optimal absorption wavelength of the material.

The radiation can come from a radiation source integrated with the extrusion device, such as a printhead. The radiation can also come from a fixed source, while the deposition surface is mobile. For example, a fabrication process for an extruded product can comprise a mobile printing plate on which a fixed extrusion device extrudes a material. A radiation source heats the printing plate in isolation before the product is extruded onto it.

In certain embodiments, the printing plate is heated to a temperature of about 30° C. to about 300° C. In certain embodiments, the printing plate is heated to a temperature of about 50° C. to about 250° C. In certain embodiments, the printing plate is heated to a temperature of about 60° C. to about 220° C.

In certain embodiments, the deposition surface is a printing plate. In certain embodiments, the deposition surface is at least one portion of a layer of a previously deposited material.

The extrusion process described above can be an extrusion molding process. It can also be a process for fabrication of an object by deposition of layers of material extruded separately or consecutively. It can also be a process for additive fabrication by deposition of fused droplets.

This disclosure also concerns an additive fabrication process comprising the following steps: heating a material, extruding a first quantity of the material towards a deposition surface, forming a deposition layer, heating at least one part of the deposition layer by a radiation, extruding at least one second quantity of the material onto the part of the deposition layer heated in this way.

The material can be heated by conduction, by convection, or by a combination of these. The material can be heated to a temperature higher than its glass transition temperature or its melting temperature.

The material used in this process can be the same material used in the embodiments of the additive fabrication process, using a printhead according to this disclosure as described above. The operational parameters for the additive fabrication process using a printhead according to this disclosure are also applicable.

The radiation can be a thermal radiation and come from a radiation source, such as a radiating plate. Depending on the absorption characteristics of the printing material, the radiation can also be another component of the electromagnetic spectrum, such as a radiation by infrared or microwave wavelengths.

The source can be integrated with an additive fabrication device, such as a printhead, or be a separate element, such as an element integrated with the fabrication chamber.

The temperature of a radiation source can be adjusted as a function of the movement speed of the source in relation to the deposition layer. The temperature of a radiation source can be adjusted as a function of an optimal absorption wavelength of the material.

According to certain embodiments, said radiation is at a temperature of about 40° C. to about 1200° C. According to certain embodiments, said radiation is at a temperature of about 100° C. to about 800° C. According to certain embodiments, said radiation is at a temperature of about 150° C. to about 600° C. According to certain embodiments, said radiation is at a temperature of about 200° C. to about 500° C. According to certain embodiments, said radiation is at a temperature of about 200° C. to about 450° C.

According to certain embodiments, a movement speed of the printhead is about 5 mm/sec to about 120 mm/sec. According to certain embodiments, in which a movement speed of the printhead is about 10 mm/sec to about 80 mm/sec According to certain embodiments, a movement speed of the printhead is from about 12.5 mm/sec to about 50 mm/sec.

According to certain embodiments, the height of said deposition layer is from about 0.07 mm to about 4 mm. According to certain embodiments, the height of said deposition layer is from about 0.1 mm to about 1.0 mm. According to certain embodiments, the height of said deposition layer is from about 0.2 mm to about 0.6 mm.

The use of the processes and devices described presents several advantages. One benefit includes the possibility of making an isolated and localized transfer of heat by radiation from a radiation source, such as a radiating plate. The radiating plate transfers the heat to a portion of the top part of the piece being fabricated, immediately before the deposition of the following layer, in order to locally increase the temperature in isolation of the printed surface. This isolated and localized heating makes it possible to decrease undesired deformations of the piece during its fabrication and the internal stresses resulting from macromolecular relaxations. This isolated and localized heating also makes it possible, in certain embodiments, to reduce the risks of thermal degradation in the printing material, by allowing a decrease in the temperature of the printing chamber.

A further benefit includes the isolated and localized increase in the temperature of the printing material close to or above the glass transition temperature or the melting temperature, which encourages a greater molecular mobility, in turn encouraging a greater molecular diffusion between the various printed layers. The molecular diffusion makes it possible to improve the cohesion or adhesion between the layers. For example, when the printing material is a polymer, molecular diffusion allows molecular chains to move at least partially and to interpenetrate the two layers of the deposited material, as illustrated in FIG. 6. A modulation of the mechanical properties under tension is observed, modulating the isotropy associated with products fabricated by additive fabrication or by extrusion.

A further benefit includes the possibility of heating at least one part of the deposition surface in isolation to a temperature close to the glass transition or melting temperature of the material. When a printing chamber is present, it is not possible to heat the printing chamber to a temperature close to or above the glass transition or melting temperature of the material, since the fabricated piece would deform permanently following the greater molecular mobility that would be observed in the material.

A further benefit includes the improvement of the structural characteristics of the product fabricated by additive fabrication. The isolated and localized increase of the temperature of the material at the deposition surface makes it possible to modulate the shrinkage rate between top layer and the deposition layer, thereby also modulating internal stresses, the maximum stress, bending resistance, impact resistance, deformation at break, the rigidity modulus, the crystallinity rate and problems with warping and delamination frequently observed for pieces with larger dimensions. The isolated and localized increase of the temperature of the material at the deposition surface also makes it possible to modulate the impermeability of the fabricated product.

A better adhesion between the layers of the product, as well as a decrease in the roughness and porosity of the product, make it possible to fabricate impermeable products, such as containers or pipes intended to contain fluids. These same structural characteristics can be modulated for a product fabricated by extrusion thanks to the isolated and localized increase of the temperature of a surface towards which the product is extruded. The radiant system heats a part of the deposition surface, which considerably improves the inter-layer adhesion. It also heats a part of the top layer, which can contribute to the decrease of the porosity rate and the increase of the contact area between the top layer and the next layer that will be subsequently deposited.

A further benefit includes the possibility of more easily printing technical or high-performance polymers, which typically require the use of a heated chamber with a controlled environment on FFF printers that do not have such technology.

Another benefit includes the isolated and localized fluidification of the fabrication material, which makes it possible to modulate the amplitude of roughness at the deposition surface, encouraging a modulation of the porosity rate in the fabricated piece.

Another benefit includes an increase in the fabrication speed. An increase in the power absorbed by the material caused by the emission by a source, such as a radiating plate, of a wavelength corresponding to one of the absorption peaks of the printing material, makes it possible to increase the movement speed of the fabrication apparatus, such as a printhead, thereby reducing the fabrication time.

Another benefit includes the improvement of interlayer adhesion of a product fabricated by additive fabrication, while avoiding overheating the material before its deposition. Since both the extruded material and the portion of the layer where it is deposited are close to or above the glass transition temperature of the material, a macromolecular diffusion between the layers fabricated in this way can be produced. This encourages the structural solidity of the product fabricated in this way, since each layer adheres more strongly to its neighboring layers.

This disclosure will be better understood with reference to the drawings.

FIG. 10 shows an embodiment of this disclosure. An additive fabrication printhead 100 comprises a radiation emission device 110 and a nozzle 130.

Radiation emission device 110 comprises a radiating plate 111, having a proximal surface 112 and a distal surface 113. The printhead is configured so that nozzle 130 is close to radiating plate 111. A distance can exist between nozzle 113 and radiating plate 111.

Nozzle 130 has an extrusion tip 131 that corresponds to its outlet. Printhead 100 is configured to receive nozzle 130 and radiation emission device 110 so that extrusion tip 131 of nozzle 130 extends past distal surface 113 of radiating plate 111 in the direction of deposition surface 202. For example, when radiating plate 111 has an annular shape, nozzle 130 is received through the center of the ring formed by radiating plate 111. In such a configuration, extrusion tip 131 is located at a shorter distance from deposition surface 202 than the distal surface 113 of radiating plate 111. Extrusion tip 131 extends past distal surface 113 by a distance that is from about 0.1 to about 500, from about 0.1 to about 200, from about 0.5 to about 50, or from about 1 to about 5 millimeters. For illustrative purposes, FIG. 10 also shows a printing plate 205 and a deposition surface 202, more specifically, a deposition layer 201 of a previously deposited material. Deposition layer 201 is a deposition surface 202. A top layer 203 is deposited by printhead 100 on deposition surface 202. The top layer, once deposited, has a top surface 204. In this illustrative example, radiating plate 110 heats a portion of deposition layer 201, including at least a portion of deposition surface 202, the material is extruded from extrusion tip 131 of nozzle 130, and the radiating plate heats at least a portion of top layer 203, including at least a portion of top surface 204. Persons skilled in the art will note that when the material is deposited on the printing plate, such as at the start of the fabrication of the product, printing plate 205 fulfills the functions of deposition layer 201, and that the surface of the printing plate on which the material is deposited fulfills the functions of deposition surface 202.

Radiating plate 111 is heated by conduction by means of a first heating element 115, which transmits thermal energy to proximal surface 112. First heating element 115 is in direct contact with proximal surface 112 of radiating plate 111. The heat from the first heating element is thus transmitted by conduction directly to radiating plate 111.

Radiating plate 111 is configured to be heated and to transmit a thermal radiation via its distal surface 113 to deposition surface 202 and top surface 204.

Radiating plate 111 in this embodiment is annular. First heating element 115 in this embodiment is annular and along the perimeter of radiating plate 111.

Printhead 100 comprises a heating block 150. Heating block 150 comprises at least one second heating element (not shown). Heating block 150 is configured to receive the at least one second heating element in at least one housing 155.

Heating block 150 also comprises at least one second thermocouple (not shown). Heating block 150 is configured to receive the at least one second thermocouple in at least one housing 156.

The at least one second heating element and the at least one second thermocouple can be functionally connected to a temperature controller (not shown) in order to control and modify the temperature of heating block 150.

Heating block 150 is configured to receive at least a portion of nozzle 130, such as its upper end. Heating block 150 is configured to receive nozzle 130 so that a printing material circulating in nozzle 130 is heated.

Radiation emission device 110 comprises a mounting case 120. Mounting case 120 is attached to at least a portion of proximal surface 112 of radiating plate 111.

Mounting case 120 defines an insulation area 121. Insulation area 121 reduces the transfer of heat between first heating element 115 and mounting case 120. Insulation area 121 comprises an air space, an insulating material, a reflecting surface, or a combination of these. Other thermal insulation options will occur to persons versed in the art who put this disclosure into practice.

Mounting case 120 defines an insulation area 122. Insulation area 122 reduces the transfer of heat between heating block 150 and mounting case 120. Insulation area 122 comprises an air space, an insulating material, a reflecting surface, or a combination of these. Other thermal insulation options will occur to persons versed in the art who put this disclosure into practice.

The size of each one of insulation areas 121 and 122 comprises a distance between the mounting case and heating block 150, or the at least one first heating element 115, from about 0 to about 50, from about 0 to about 10, or from about 0 to about 5 millimeters.

Mounting case 120 is configured to be attached to heating block 150 by a plurality of means. For example, it is attached by means of mounting screws 129.

Thermal barrier 170 can be an extension of heating block 150, from cold area 180, or an independent component that is configured to be attached between cold area 180 and heating block 150.

According to certain embodiments, radiating plate 111 is configured to protect heating element 115 from any direct contact with the polymer coming from nozzle 130, from deposition surface 202 or from the top surface 204. This protection element makes it possible to reduce the distance separating distal surface 113 from deposition surface 202 and top surface 204 and because of this to increase the amount of energy transferred to the polymer and to minimize the length of nozzle 130.

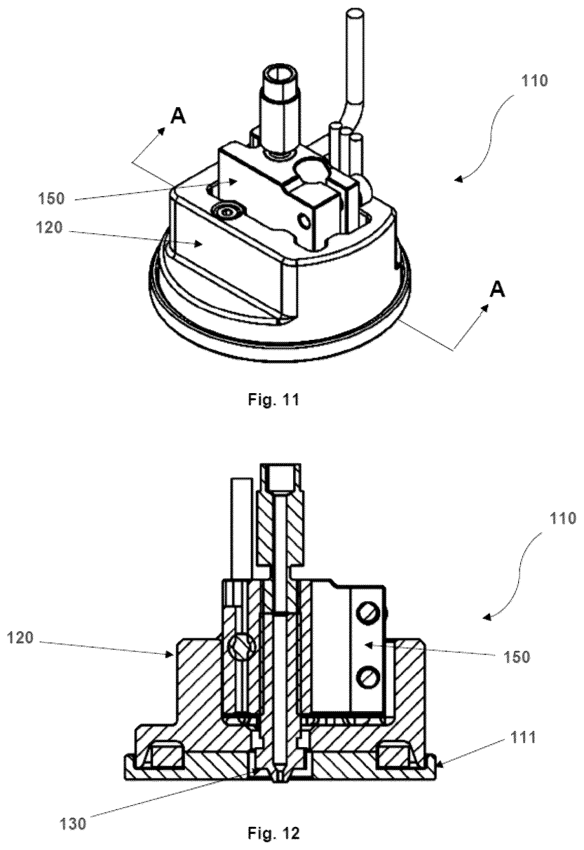

In reference to FIG. 11, an example embodiment of a radiation emission device 110 of this disclosure is presented. The device comprises a radiation emission device 111 and a mounting case 120. Radiation emission device 110 is configured to be attached to heating block 150 by means of mounting case 120.

In reference to FIG. 12, a cross section in the direction AA of the example embodiment from FIG. 11 is presented. Radiating plate 111 and mounting case 120 form a radiation emission device 110. Radiating plate 111 is configured to be attached to heating block 150 by means of mounting case 120. A nozzle 130 is received in heating block 150. Nozzle 130 extends past radiating plate 111.

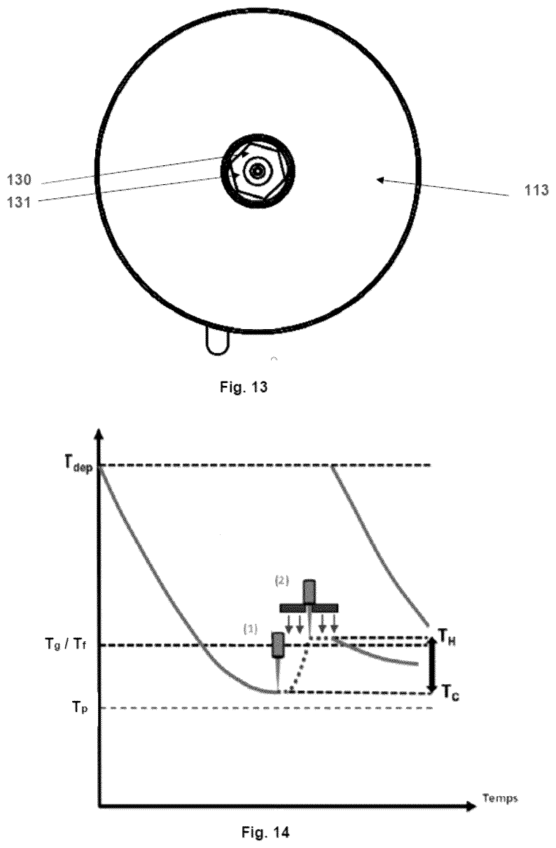

In reference to FIG. 13, a view from underneath an example embodiment of this disclosure is presented. A radiating plate 111 with an annular shape has a distal surface 113 forming a ring. A nozzle 130 is configured to be received through the space defined by the ring. Extrusion tip 131 of nozzle 130 extends past distal surface 113 of radiating plate 111.

FIG. 14 shows the temperature profiles of two layers of a product fabricated by additive fabrication over time, according to an additive fabrication process using the techniques from this disclosure. In this illustrative example, the process takes place in a fabrication chamber heated to a temperature Tₚ. A material is extruded towards a deposition surface, the material having a temperature T_{dep}. The additive fabrication apparatus, such as a printhead or another extrusion device, moves while continuing fabrication. The deposited material cools and its temperature decreases to below the glass transition temperature T_{g} or the melting temperature Tₘ of the material. The temperature of the material while cooling tends towards the temperature of the printing plate (not shown). The additive fabrication apparatus prepares to deposit the next layer of material. Just before the deposition of a second layer, the temperature Tc of at least one portion of the deposited layer is heated above T_{g} or Tₘ to a temperature TH. Material is then extruded towards the first layer, forming a second layer.

In FIG. 14, the thermal profiles with or without use of the heating system are indicated by the numbers 1 and 2. Scenario 1 indicates the thermal profile without the use of a radiant heating system. Layer 2 is then deposited on layer 1 when the latter is below its glass transition temperature. Scenario 2 indicates the thermal profile when a radiant heating system is active. Layer 2 is then deposited on layer 1 when at least a portion of the latter is at a temperature above its glass transition or melting temperature.

An example process for additive fabrication using printhead 100 is presented. In this example process, a printing material, such as a polymer, is extruded through a nozzle onto a deposition surface 202.

A quantity of printing material circulating in nozzle 130 is heated. The material can be heated to a temperature above its glass transition temperature. The material can also be heated to a temperature above its melting temperature.

Printhead 100 is moved in relation to a deposition surface 202. Radiating plate 111 is heated by the at least one first heating element 115 and transmits a thermal energy towards deposition surface 202. At the start of the process, the deposition surface is a printing plate 205. After the deposition of a first layer of the material, deposition surface 202 is part of a deposition layer 201.

A first quantity of the heated material in nozzle 130 is extruded through extrusion tip 131 towards the deposition surface, forming a top layer 203. After the extrusion, radiating plate 111 transmits a thermal radiation towards top surface 204 of top layer 203. Subsequently, top layer 203 can cool below its glass transition temperature.

Printhead 100 starts the deposition of the following layer. Top layer 203 described above is not deposition layer 201. Radiating plate 111 transmits a thermal radiation towards deposition surface 202 of deposition layer 201. The radiation heats at least a portion of deposition layer 201 to a temperature close to or above the glass transition or melting temperature of the material. A second quantity of the material circulating in nozzle 130 is extruded through extrusion tip 131 on deposition layer 201, forming a top layer 203.

The process described above can be repeated for the following layers. Thus, the second quantity of the material extruded from nozzle 130 forms the layer that will be subsequently at least partially heated by radiating plate 111 before receiving an additional quantity of the material.

This disclosure can be further understood with the help of the following studies. The tests are not limiting and only demonstrate the benefits of certain operational parameters of an additive fabrication process that uses the teachings from this disclosure. Other benefits, fabrication methods and other suitable operational parameters will occur to persons who put this disclosure into practice, with no deviation from the information stated here.

### EXAMPLES

### Example 1

### Additive Fabrication Parameters Used

FIG. 15 shows a specimen model printed according to the Z-X axes, i.e. an ASTM D638 type IV standardized specimen.

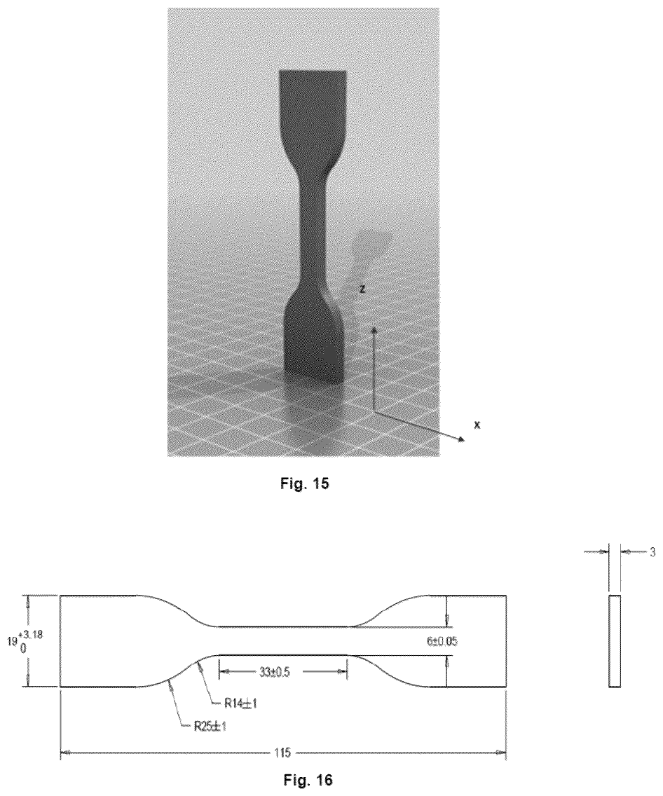

FIG. 16 shows the dimensions in millimeters of the printed specimen models.

The additive fabrication printing tests were done from an Aon-M2 printer from the Quebec company AON3D in order to validate the effectiveness of the radiant heating system integrated with the printhead.

The specimens are printed according to the Z-X axes in order to directly validate the increase of inter-layer adhesion during testing under tension.

The consumable used is a Ultem 1010 polyetherimide (PEI) filament, the diameter of which is 1.75 mm. This filament is sold by the company 3DXTECH Additive Manufacturing.

PEI 1010 is a high-performance amorphous thermoplastic polymer. It was used to validate the effectiveness of the radiant heating system because its glass transition temperature is very high (217° C.), considerably complicating its 3D printing with FDM or FFF technologies.

The specimens are printed simultaneously in lots of 6 samples, in order to increase the time between the deposition of two successive layers.

Before the printing operation, the spool of PEI 1010 is dried at 120° C. for a minimum of 4 hours in an oven. The samples are then printed according to the following printing parameters:
Printing nozzle diameter: 0.6 mm
Heating block temperature: 380° C.
Printing chamber temperature: 120° C.
Printing plate temperature: 150° C.
Extrusion factor: 0.85
Layer height: 0.2 mm
Layer width: 0.69 mm
Filling rate: 100%
Filling orientation: 0 degrees at all times.
Printhead movement speed: variable, from 12.5 mm/sec to 50 mm/sec
Radiant heating system temperature: variable, between 330° C. and 420° C.

### Evaluation Method of Mechanical Properties Under Tension

Tension testing is used to evaluate the mechanical properties of a sample undergoing a tensile load. The tests were conducted on a Zwick/Roell Z030 tension apparatus equipped with a 30 kN load cell and a video extensometer. Type IV specimens were analyzed according to the ASTM D638 standard after conditioning at 23° C. (±2° C.) and 50% (±10%) humidity for at least 48 hours. The Young's modulus (E), maximum stress at maximum (σₘₐₓ) and deformation at break (εᵣᵤₚ) were measured at a constant stretching speed of 5 mm/min. Inconsistent data were eliminated and a minimum of 4 samples were used to calculate the mean and standard deviation. The results obtained are compiled in the form of comparative graphs.

### Young's Modulus

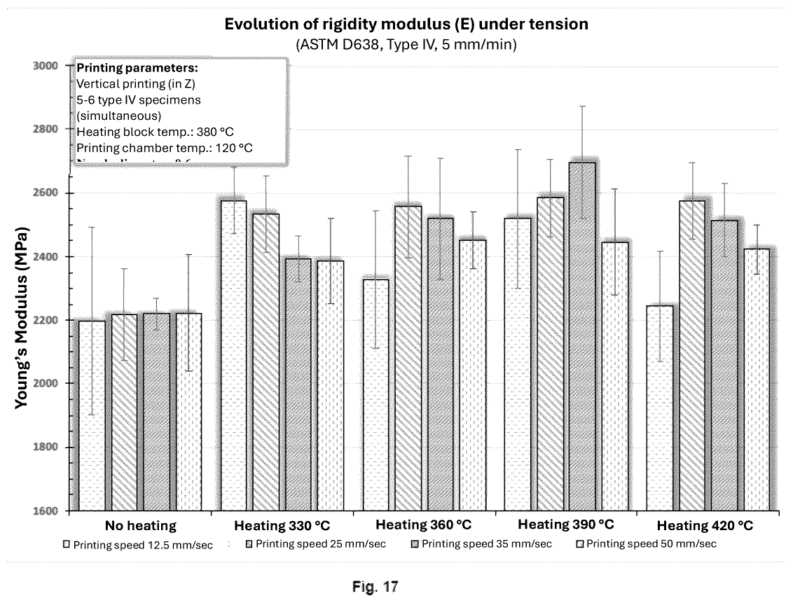

In reference to FIG. 17, the Young's modulus of samples evolves as a function of the printing speed and the heating configuration. Tests with 4 different printing speeds (12.5, 25, 35 and 50 mm/sec) and with 5 configurations of heating with the radiating plate (no heating, 330° C., 360° C., 390° C. and 420° C.) are illustrated.

When the radiating plate is not used, the Young's modulus is relatively constant at 2200 MPa, no matter what the print speed.

When the radiating plate is used, a high Young's modulus is observed at all temperatures. This increase in tensile rigidity can be explained by a decrease in the porosity rate as well an improvement in the inter-layer adhesion.

A maximum Young's modulus of 2697 MPa is obtained when the radiating plate temperature is set at 390° C. and the print speed is 35 mm/sec.

A significant standard deviation is observed for all additive fabrication printing tests. This more significant variation is frequently observed for the FDM and FFF additive fabrication processes, compared to injection molding or compression.

### Maximum Stress

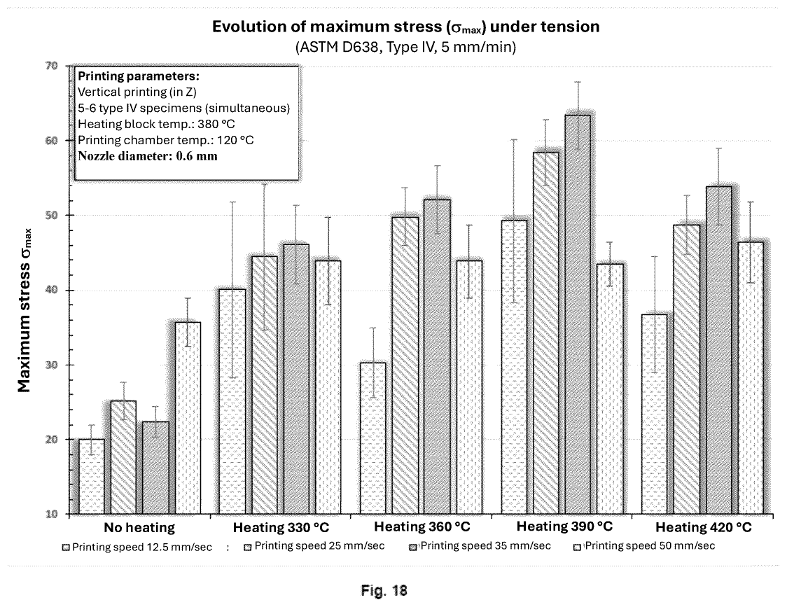

In reference to FIG. 18, the maximum stress during tensile testing evolves as a function of the print speed (movement speed of the printhead) and the temperature of the radiating plate.

The lowest maximum stress (20 MPa) is observed when the radiant heating system is not activated and the lowest print speed of 12.5 mm/sec is used. The conditions are then met so that the temperature at the surface of the previously printed layer is its lowest, considerably limiting the molecular diffusion at the interface. Diffusion remains low when the temperature of the polymer around the previous layer remains lower than the glass transition temperature of the polymer, or 217° C. in the case of PEI.

An increase in the print speed generally encourages an increase of the tensile maximum stress. This makes it possible to reduce the temperature necessary for the printing of a layer, limiting the fall in temperature at the surface of the printed piece. A higher temperature encourages a greater molecular diffusion at the interface between the layers.

On the other hand, when a higher speed of 50 mm/sec is used, the tendency reverses and the maximum stress reduces. Too high a movement speed could induce defects during printing (e.g. inertial effects at the printhead can induce small errors of positioning, causing an increase in the porosity rate).

The use of the radiating plate makes it possible to considerably increase the maximum stress obtained, and this is true for all print speeds tested.

When the temperature used on the radiating plate is 390° C., the maximum stress reached a peak at 63 MPa, a value close to 3 times above that obtained when the radiant heating system is not activated (22 MPa). The radiant heating system them makes it possible to maintain a temperature at the surface of the printed piece above its glass transition temperature (217° C.), despite a printing chamber temperature that is only at 120° C. This encourages a greater molecular diffusion. The maximum stress at Z is then similar to the maximum stress observed for a printed sample at XY, thereby eliminating the phenomenon of anisotropy.

A temperature of 420° C. at the radiating plate encourages a decrease of the maximum stress compared to a temperature of 390° C. According to one theory, a degradation phenomenon at the surface of the polymer could partially explain this decrease of the maximum stress.

### Elongation at Break

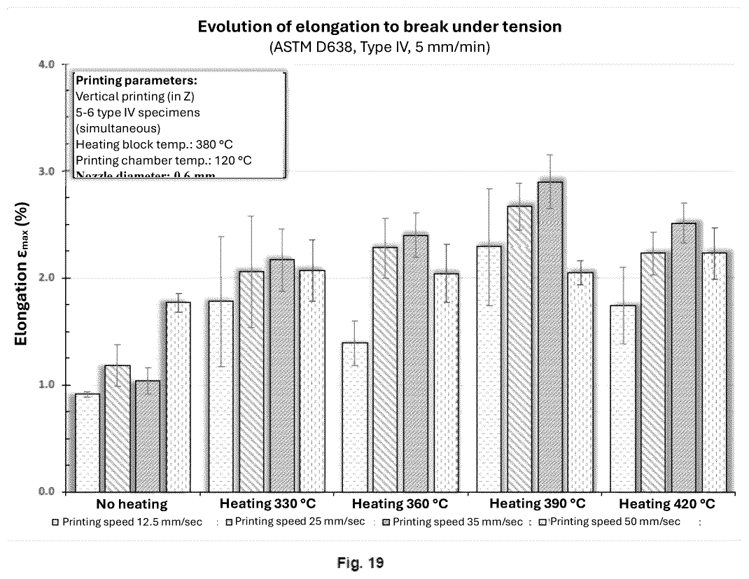

In reference to FIG. 19, the elongation to break during tensile testing evolves as a function of the print speed and the temperature of the radiating plate.

Elongation at break is low (about 1%) when the radiant heating is not used. Rapid delamination at the interface between the layers during tensile testing limits the stress that it is possible to apply to the sample, thereby limiting its elastic deformation (Hooke's law). Like a spring, the greater the force imposed, the greater the deformation (elastic or plastic) will be.

Elongation at break increases considerably when the radiant heating system is activated. A better cohesion between the layers makes it possible to increase the stress exerted on the specimen before obtaining a break. A higher stress results in a more significant elastic deformation of the material (Hooke's law).

An increase in the temperature of the radiating plate makes it possible to increase the elongation at break up to a temperature of 390° C. When the temperature of the radiating plate reaches 420° C., the tendency reverses and the elongation at break diminishes appreciably. This same phenomenon is also observed with the maximum stress.

For each radiant heating configuration, the maximum elongation is always obtained when the print speed is adjusted to 35 mm/sec.

Elongation at break reaches a maximum value of 2.9% when the radiant temperature is 390° C. and the print speed is 35 mm/sec.

An increase in print speed encourages a more significant elongation at break, with the exception of the speed of 50 mm/sec, which encourages an inversion of the tendency.

### Porosity

In reference to FIGS. 20A and 20B, the analysis by x-ray tomography provides information on the internal structure of the samples scanned. A comparative study is done between two series of specimens printed at a speed of 35 mm/sec, one printed without the use of the radiant heating system (FIG. 20A), and the other with a radiant heating system operating at 390° C. (FIG. 20B). The porosity rate measured inside of the samples printed without the radiant system is 8%, while the samples printed with the heating element indicate significantly lower porosity rates of 5%. The significant decrease of the porosity rate indicates that there is less empty space between two consecutive filaments, which encourages a better adhesion between the layers.

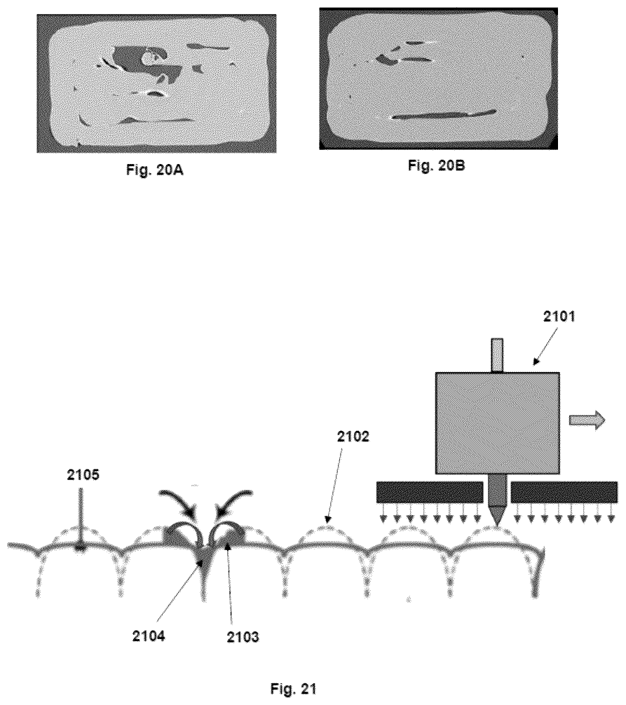

In reference to FIG. 21, a potential mechanism contributing to the reduction of the porosity rate in FIGS. 20A and 20B includes a redistribution of the surface roughness. The surface finish before the passage of the radiant heating system 2101 is indicated on dotted line 2102. If radiant heating system 2101 makes it possible to increase the temperature of the printed surface above the glass transition temperature (217° C.), a certain molecular mobility develops within the polymer and then allows the material that is located on top of the rough area 2103 to flow towards the trough of the triangular gaps 2104 that form between the filaments (shaded areas), thereby reducing the porosity rate. The surface finish after the passage of the radiant heating system 2101 is indicated on solid line 2105. A reduction in surface roughness also makes it possible to increase the contact surface between the layers, encouraging a better molecular diffusion and the increase of mechanical properties.

### Example 2

The additive fabrication tests were done from an AonM2 printer from the Quebec company AON 3D, A Stratasys F370 printer, and a Prusa i3 Mk3s+ printer, in order to validate the effectiveness of the radiant heating system integrated with the printhead when printing with the ABS M30 from Stratasys.

The specimens are printed according to the Z-X axes in order to directly validate the increase of inter-layer adhesion during testing under tension. The printed samples are ASTM D638 type IV standardized specimens, as illustrated in FIG. 16.

The consumable used is an M30 Ivory acrylonitrile butadiene styrene (ABS) filament (formulation for Stratasys F123 printers) the diameter of which is 1.75 mm. This filament is sold by the company Stratasys.

The M30 ABS is an amorphous technical thermoplastic polymer with a glass transition temperature at 105° C. It is used to compare the effectiveness of the radiant heating system on a Stratasys F370 commercial printer with an air-conditioned chamber, then on an Aon M2 FDM printer with an open configuration also having an air-conditioned chamber, as well as a small Prusa Mk3s+ printer not having an air-conditioned printing chamber.

The specimens are printed simultaneously in lots of 6 samples, in order to increase the time between the deposition of two successive layers.

### Additive Fabrication Parameters Used

Before the printing operation, the spool of M30 ABS is dried at 80° C. for a minimum duration of 8 hours in an oven and then it is stored in an air-conditioned chamber at 75° C. The samples are then printed according to the following additive fabrication parameters:
Printing nozzle diameter: 0.6 mm (Prusa and Aon M2) and T14 or 0.356 mm (Stratasys)
Heating block temperature: 295° C. (Prusa i3 Mk3s+) and 300° C. (Aon M2)
Printing chamber temperature: 85° C. (Stratasys and Aon M2)
Printing plate temperature: 100° C. (Aon M2 and Prusa), 85° C. (Stratasys)
Extrusion factor: 0.98 (Prusa and Aon M2)
Layer height: 0.2 mm (all printers)
Filling rate: 100%
Filling orientation: 0 degrees (at all times)
Printhead movement speed: 35 mm/sec
Radiant heating system temperature: variable, between 220° C. and 280° C.

### Evaluation of Mechanical Properties Under Tension

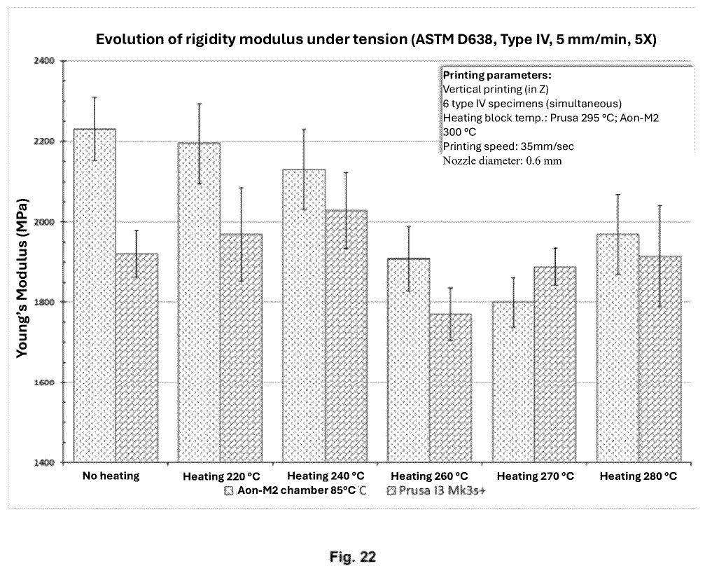

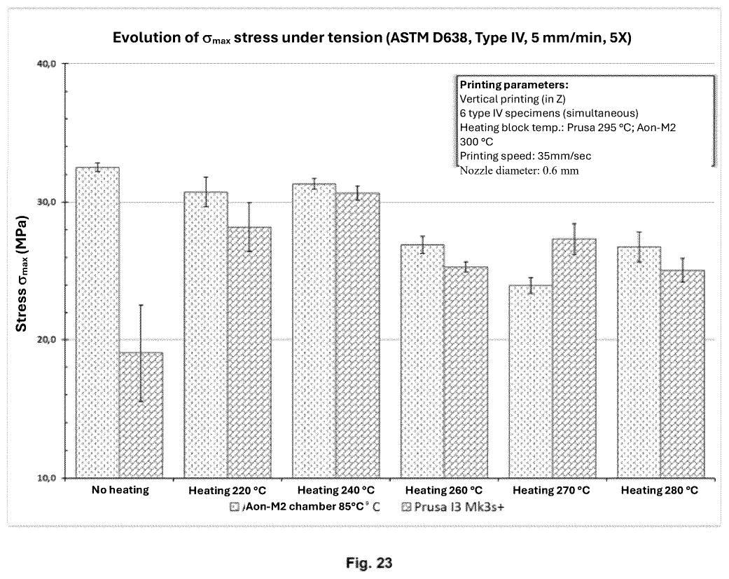

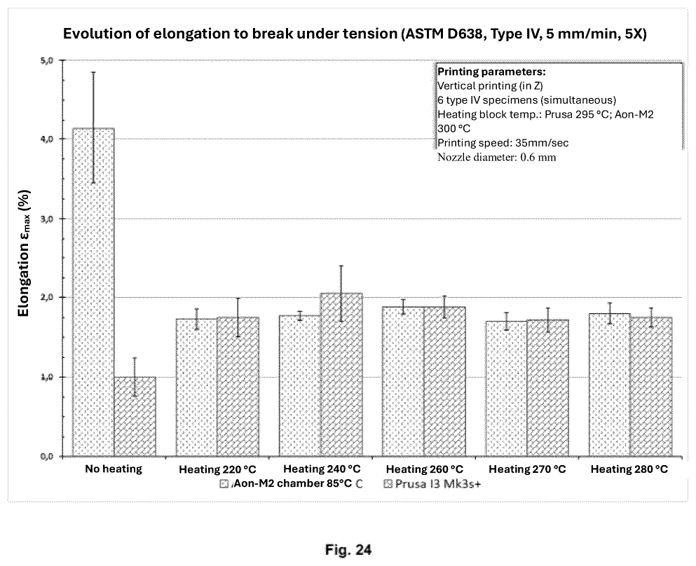

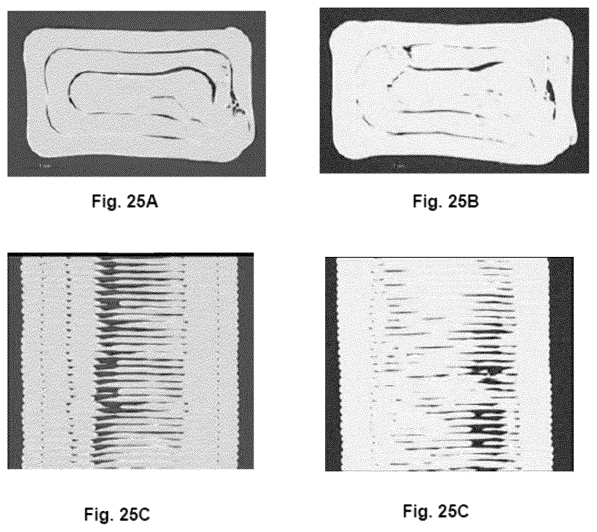

Tension testing is used to evaluate the mechanical properties of a sample undergoing a tensile load. The tests were conducted on a Zwick/Roell Z030 tension apparatus equipped with a 30 kN load cell and a video extensometer. Type IV specimens were analyzed according to the ASTM D638 standard after conditioning at 23° C. (±2° C.) and 50% (±10%) humidity for at least 48 hours. The Young's modulus (E), maximum stress (o max) and deformation at break (εrup) were measured at a constant stretching speed of 5 mm/min. Inconsistent data were eliminated and a minimum of 5 specimens were used to calculate the mean and standard deviation. The results obtained are compiled in the form of comparative graphs in FIG. 22, FIG. 23 and FIG. 24.

### Young's Modulus

FIG. 22 illustrates the evolution of the Young's modulus for the selected printers and for the 6 heating configurations with the radiating plate (no heating, 220° C., 240° C., 260° C., 270° C. and 280° C.).

When the radiating plate is not used, printing with the M30 ABS on an Aon-M2 printer having a chamber heated to 85° C. allows the increase of the rigidity modulus by 14% at 2,231±78 MPa, compared to a modulus of 1,921±58 MPa on the Prusa printer, which does not have a heated chamber. In summary, the use of the heated chamber allows for the improvement of the rigidity modulus.

When the radiating plate is adjusted to 240° C., the rigidity modulus obtained on a Prusa printer is 2,028±94 MPa. This result is similar to the modulus obtained on an Aon-M2 printer, which rises to 2,130±99 MPa.

The use of the radiating plate on a Prusa printer makes it possible to obtain a rigidity modulus equivalent to that obtained on an Aon-M2 printer not having a radiating element, but equipped with a chamber heated to 85° C. This increase in tensile rigidity observed on the Prusa printer can be explained by a decrease in the porosity rate as well an improvement in the inter-layer adhesion.

A slight downward tendency of the Young's modulus is observed when the temperature of the radiating plate increases beyond 240° C.

### Maximum Stress

FIG. 23 illustrates the evolution of maximum stress during tensile tests as a function of the printer used and the temperature of the radiating plate.

The lowest maximum stress, or 19.0±3.5 MPa is observed when the radiant heating system is not activated and the printing is done on a Prusa printer that does not have a heated chamber. The conditions are then met so that the temperature at the surface of the previously printed layer is its lowest, considerably limiting the molecular diffusion at the interface between the previously deposited layer and the following layer. Diffusion remains low when the temperature at the surface of the previously deposited layer remains lower than the glass transition temperature of the polymer, or 105° C. in the case of the M30 ABS.

When the same printing is done on an Aon-M2 printer equipped with a chamber heated to 95° C., the maximum stress increases to 32.5±0.3 MPa, or a difference of 7.1% compared to the Prusa printer. The heated chamber encourages an increase in the temperature at the surface of the previously printed layer as well as a better molecular diffusion at the interface between the deposited layers.

The use of the radiating plate makes it possible to considerably increase the maximum stress obtained on a Prusa printer that does not have a heated chamber. When the temperature of the radiating plate is adjusted to 240° C., the stress increases to 30.7±0.5 MPa, or an increase of 61.5% compared to the same printing done without the radiating plate. Moreover, the stress obtained is comparable to that obtained on an Aon-M2 printer equipped with a chamber heated to ° C. This result demonstrates a better adhesion at the interface between the layers. The radiant heating system them makes it possible to maintain a temperature at the surface of the printed piece above its glass transition temperature (105° C.) despite the presence of an ambient temperature that is about 22° C. Without wanting to be held by theory, this seems to encourage a greater molecular diffusion.

An increase in the temperature of the radiating plate beyond 240° C. encourages a progressive decrease in the maximum stress. A degradation phenomenon at the surface of the polymer could partially explain this decrease.

The use of the radiating plate does not make it possible to significantly increase the maximum stress obtained on an Aon-M2 having a heated chamber.

According to the Stratasys M30 ABS technical data sheet, the maximum stress obtained on a Fortus 900 printer having a T16 (0.4 mm) nozzle and printing layers with a thickness of 0.254 mm is 27.5±0.28 MPa. This result is lower than that obtained on a low-cost Prusa printer, equipped with a radiant heating system.

According to an additive fabrication test done with a T14 (0.356 mm) nozzle and printing layers with a thickness of 0.254 mm on a Stratasys F370 printer, the maximum stress obtained is 20.4±6.1 MPa. This result is clearly lower than that obtained on a low-cost Prusa printer, equipped with a radiant heating system.

### Elongation at Break

FIG. 24 illustrates the evolution of elongation at break during tensile tests as a function of the printer used and the temperature of the radiating plate.

Elongation at break reaches a maximum value of 4.1±0.7% when the sample is printed in an Aon-M2 printer without the use of the radiating plate. On the other hand, the high standard deviation shows a significant variation in stretching.

For the Prusa printer, the elongation at break is low, at 1.0±0.24% when the radiant heating is not used. Rapid delamination at the interface between the layers limits the amplitude of the stress that is possible to apply before its break, encouraging a low amplitude deformation (Hooke's law). Like a spring, the lower the force imposed before break, the smaller the deformation will be.

For the Prusa printer, the elongation at break doubles from 1.0±0.24% to 2.1±0.35% when the radiant heating is adjusted to 240° C. A better adhesion between the layers makes it possible to apply a higher stress before the breaking of the sample. This becomes more deformed (Hooke's law).

When the radiating plate is activated, the elongation at break remains similar and constant (between 1.8 and 2%) between the Aon-M2 printer, which has a chamber heated to 85° C., and the Prusa i3 Mk3s±printer, which does not have an air-conditioned chamber, regardless of the temperature of the radiating plate.

### Porosity

The analysis by x-ray tomography provides information on the internal structure of the samples scanned. A comparative study is done between two series of specimens printed at a speed of 35 mm/sec, one printed with a Prusa i3 Mk3s±printer without the use of the radiant heating system, and the other with a radiant heating system operating at 240° C. The porosity rate measured inside of the samples printed without the radiant heating is 3.0%, while the samples printed with the heating element indicate significantly lower porosity rates of 1.6%. The significant decrease of the porosity rate indicates that there is less empty space between two consecutive filaments, which encourages a better adhesion between the layers.

In conclusion, the radiant heating system of this disclosure makes it possible to obtain, using the Stratasys M30 ABS, relatively similar tensile mechanical properties between an FDM printer having an air-conditioned chamber and a Prusa i3 Mk3s±FFF printer that does not have an air-conditioned chamber.

This disclosure was described with reference to certain example embodiments. Nothing in this disclosure limits its teachings to only the embodiment described herein. Other useful embodiments and other useful utilizations of the devices, methods, processes and techniques described here will be apparent to skilled persons who put this disclosure into practice. The general principles stated in this disclosure can be applied to other embodiments and applications without deviating from their information.

### REFERENCES

1. The APF Process, online https://www.arburg.com/en/products-and-services/additive-manufacturing/the-apf-process/2.
2. B. Jellimann, L'impression 3D FDM, 2020, Editions ENI, Nantes
3. J. R. C. Dizon et al., Mechanical characterization of 3D-printed polymers, Additive Manufacturing 20 (2018), 44-67
4. Q. Sun et al., Effect of processing conditions on the bonding quality of FDM polymer filaments, Rapid Prototyping Journal 14 (2) (2008), 72-80
5. A review on 3D printed matrix polymer composites: its potential and future challenges—Scientific illustration on ResearchGate, online https://www.researchgate.net/figure/FDM-printed-fiber-reinforced-composite-with-the-reduction-in-inter-layer-porosity-but_fig15_337905012
6. W. Lin et al., Single-layer temperature-adjusting transition method to improve the bond strength of 3D-printed PCL/PLA parts, Composites Part A: Applied Science and Manufacturing 115 (2018), 22-30
7. Source for illustration of printhead movement: https://grabcad.com/library/astm-d638-14-type-iv-1

1. An additive fabrication printhead, comprising
a radiation emission device comprising
a radiating plate comprises a proximal surface and a distal surface, and
at least one first heating element
a printing nozzle configured to deliver a printing material;
in which the radiation emission device is configured to receive the printing nozzle so that said nozzle is coupled to said radiating plate,
in which said nozzle comprises an extrusion tip, and in which said radiation emission device receives said nozzle so that said extrusion tip of said printing nozzle extends beyond said distal surface of said radiating plate;
in which said at least one first heating element is configured to transmit a thermal energy by conduction to said proximal surface, and comprising a heating block comprising at least one second heating element and configured to receive an upper end of said nozzle, in which the heating block is configured to heat the printing material circulating in the printing nozzle.

2. The printhead according to claim 1, in which said extrusion tip extends from about 0.1 to about 500 mm beyond said distal surface of said radiating plate.

3-5. (canceled)

6. The printhead according to claim 1, in which said radiating plate is configured to transmit the thermal energy from said at least one first heating element by radiation via said distal surface to the printing material delivered onto a deposition surface situated under the distal surface.

7. The printhead according to claim 1, configured to be mobile in relation to a deposition surface.

8. The printhead according to claim 1, further comprising a mounting case configured to connect said proximal surface of said radiating plate and said heating block.

9. The printhead according to claim 1, in which said radiation emission device further comprises at least one first thermocouple in direct contact with said at least one first heating element.

10. (canceled)

11. The printhead according to claim 1, further comprising a first temperature controller functionally connected to said at least one first heating element.

12-13. (canceled)

14. The printhead according to claim 1, in which said heating block comprises said at least one first heating element and said at least one second heating element.

15. The printhead according to claim 1, in which said at least one first heating element and said at least one second heating element form a single heating element and in which the radiating plate is configured to transmit the thermal energy from said sole heating element by radiation via said distal surface to the printing material delivered onto a deposition surface situated under the distal surface.

16. The printhead according to claim 8, in which said mounting case defines an insulation area between said case and said at least one first heating element.

17. The printhead according to claim 8, in which said mounting case defines an insulation area between said case and the heating block.

18. The printhead according to claim 16, in which the insulation area comprises a space of about 0 to about 100 mm.

19. The printhead according to claim 16, in which the insulation area comprises a space of about 0.1 to about 50 mm.

20. The printhead according to claim 16, in which the insulation area comprises a space of about 1 to about 10 mm.

21. The printhead according to claim 16, in which the insulation area comprises at least any one of: a reflective surface, an insulating material and an air space.

22. The printhead according to claim 1, in which said radiating plate has an annular shape.

23-25. (canceled)

26. The printhead according to claim 1, in which the printing nozzle has a diameter from about 0.1 mm to about 10 mm.

27-28. (canceled)

29. The printhead according to claim 1, in which the printing nozzle has a diameter from about 0.2 mm to about 0.8 mm.

30. The printhead according to claim 1, in which said distal surface as an area from about 200 to about 200,000 mm².

31. (canceled)

32. The printhead according to claim 1, in which said distal surface as an area from about 1000 to about 2000 mm².

33-156. (canceled)
